(19) United States
(12) Patent Application Publication
(10) Pub. No.: US 2018/0011179 A1
(43) Pub. Date: Jan. 11, 2018

(54) DETECTING SOUNDING SEQUENCES IN PACKET EXTENSIONS

(71) Applicant: QUALCOMM Incorporated, San Diego, CA (US)

(72) Inventors: Xiaoxin Zhang, Sunnyvale, CA (US); Ning Zhang, Saratoga, CA (US); Youhan Kim, San Jose, CA (US); Rahul Malik, San Diego, CA (US); James Cho, Mountain View, CA (US)

(21) Appl. No.: 15/643,188

(22) Filed: Jul. 6, 2017

Related U.S. Application Data
(60) Provisional application No. 62/360,232, filed on Jul. 8, 2016.
(60) Provisional application No. 62/363,049, filed on Jul. 15, 2016.
(60) Provisional application No. 62/368,151, filed on Jul. 28, 2016.
(60) Provisional application No. 62/376,370, filed on Aug. 17, 2016.

(51) Int. Cl. G01S 11/02; H04L 29/06; H04B 7/06; H04W 84/12

(52) U.S. Cl. CPC G01S 11/026; H04L 69/22; H04B 7/06; H04W 84/12

(57) ABSTRACT

This disclosure provides systems, methods and apparatuses for detecting a presence of long training fields (LTFs) in packet extensions of high-efficiency (HE) packets. An apparatus requests a length of packet extensions to be used for a ranging operation. The apparatus receives an HE packet including a packet extension containing a selected number of LTFs based at least in part on the requested packet extension length. The apparatus performs the ranging operation based on a determination that the packet extension contains LTFs. In some aspects, the apparatus detects a presence of LTFs in the packet extension based on a bit provided in the HE packet. In some other aspects, the apparatus detects a presence of LTFs in the packet extension by extracting sequences from the packet extension.

### CROSS-REFERENCE TO RELATED APPLICATIONS

This Patent Application claims priority to U.S. Provisional Patent Application No. 62/360,232 entitled “PROTOCOL SEQUENCES FOR RANGING OPERATIONS” filed on Jul. 8, 2016, to U.S. Provisional Patent Application No. 62/363,049 entitled “PACKET EXTENSIONS FOR USE IN ANGLE ESTIMATION” filed on Jul. 15, 2016, to U.S. Provisional Patent Application No. 62/368,151 entitled “DETECTING HE-LTFs IN PACKET EXTENSIONS” filed on Jul. 28, 2016, and to U.S. Provisional Patent Application No. 62/376,370 entitled “PROTOCOL SEQUENCES FOR RANGING OPERATIONS” filed on Aug. 17, 2016, all assigned to the assignee hereof. The disclosures of all prior Applications are considered part of and are incorporated by reference in this Patent Application.

### TECHNICAL FIELD

This disclosure relates generally to wireless networks, and specifically to indicating and detecting the presence of sounding sequences in packets used for ranging operations between wireless devices.

### DESCRIPTION OF THE RELATED TECHNOLOGY

The recent proliferation of Wi-Fi® access points in wireless local area networks (WLANs) has made it possible for positioning systems to use these access points for position determination, especially in areas where there is a large concentration of active Wi-Fi access points (such as urban cores, shopping centers, office buildings, sporting venues, and so on). For example, a wireless device such as a cell phone or tablet computer may use the round-trip time (RTT) of signals exchanged with an access point (AP) to determine the distance between the wireless device and the AP. Once the distances between the wireless device and three APs having known locations are determined, the location of the wireless device may be determined using trilateration techniques.

Sounding sequences may be used during ranging operations to determine multiple round-trip time (RTT) values for each signal exchange between wireless devices. Sounding sequences also may be used to estimate angle information (such as Angle of arrival (AoA) and angle of departure (AoD) information) of wireless signals exchanged between wireless devices. Because estimating angle information based on sounding sequences may consume more power and resources than determining RTT values, it may be desirable to inform wireless devices as to the presence of sounding sequences in wireless signals, for example, so that the wireless devices may prepare to receive and process the sounding sequences.

### SUMMARY

The systems, methods and devices of this disclosure each have several innovative aspects, no single one of which is solely responsible for the desirable attributes disclosed herein.

One innovative aspect of the subject matter described in this disclosure can be implemented in a wireless network to perform ranging operations between a first wireless device and a second wireless device. The first wireless device can transmit, to the second wireless device, a frame requesting a length of packet extensions to be used for the ranging operation. In some aspects, the frame can be a fine timing measurement (FTM) request frame. The first wireless device can receive, from the second wireless device, a high efficiency (HE) packet including a packet extension that contains a selected number of long training fields (LTFs). The selected number of LTFs can be based at least in part on the requested packet extension length. In some aspects, the HE packet can encapsulate an FTM action frame. In some implementations, the LTFs contained in the packet extension can be high-efficiency long training fields (HE-LTFs), very-high-throughput long training fields (VHT-LTFs), high-throughput long training fields (HT-LTFs), or legacy LTFs. The HE-LTFs can be orthogonal to each other, and in some aspects can be based on (or derived from) a high-efficiency null data packet (HE-NDP). In some other implementations, the packet extension can be an HE-NDP.

The first wireless device can determine that the packet extension contains LTFs, and can perform the ranging operation with the second wireless device based on a determination that the packet extension contains LTFs. In some implementations, the first wireless device can detect, in a preamble of the HE packet, a bit indicating that the packet extension contains LTFs. In some other implementations, the first wireless device can extract patterns from the packet extension, and can correlate the extracted patterns with a number of reference sequences to determine whether the packet extension contains LTFs. The first wireless device can estimate angle of departure (AoD) information or angle of arrival (AoA) information of the HE packet based on the selected number of LTFs contained in the packet extension. The first wireless device also can transmit, to the second wireless device, a feedback frame including the estimated AoD information or AoA information.

Another innovative aspect of the subject matter described in this disclosure can be implemented as a method for performing a ranging operation between wireless devices. The method can include transmitting, to a wireless device, a frame requesting a length of packet extensions to be used for the ranging operation; receiving, from the wireless device, a high efficiency (HE) packet including a packet extension that contains a selected number of long training fields (LTFs), wherein the selected number of LTFs is based at least in part on the requested packet extension length; determining that the packet extension contains LTFs; and performing the ranging operation with the wireless device based on a determination that the packet extension contains LTFs. The method also can include estimating angle of departure (AoD) information or angle of arrival (AoA) information of the HE packet based on the selected number of LTFs contained in the packet extension, and transmitting, to the wireless device, a feedback frame including the estimated AoD information or AoA information.

Another innovative aspect of the subject matter described in this disclosure can be implemented in a wireless network to perform ranging operations between a first wireless device and a second wireless device. The second wireless device can receive, from the first wireless device, a frame requesting a length of packet extensions to be used for the ranging operation. In some aspects, the frame can be a fine timing measurement (FTM) request frame. The second wireless device can select a number of long training fields (LTFs) based, at least in part, on the requested packet extension length. In some aspects, the second wireless device can select the number of LTFs by determining a number of antennas from which to transmit the HE packet extension, and determining a number of spatial streams upon which to transmit the packet extension, wherein the selected number of LTFs is further based on at least one of the determined number of antennas and the determined number of spatial streams. In some other aspects, the second wireless device also can determine a size or duration of the LTFs to be included within the packet extension, and the selected number of LTFs can further be based on the size or duration of the LTFs.

In some implementations, the LTFs contained in the packet extension can be high-efficiency long training fields (HE-LTFs), very-high-throughput long training fields (VHT-LTFs), high-throughput long training fields (HT-LTFs), or legacy LTFs. The HE-LTFs can be orthogonal to each other, and in some aspects, can be based on (or derived from) a high-efficiency null data packet (HE-NDP). In some other implementations, the packet extension can be an HE-NDP.

The second wireless device can transmit, to the first wireless device, a high efficiency (HE) packet including a packet extension containing the selected number of LTFs. In some aspects, the HE packet can encapsulate an FTM action frame. In some implementations, the second wireless device can transmit a first group of LTFs using a first set of antennas, and can transmit the first group of LTFs using a second set of antennas, offset in time relative to the transmission of the first group of LTFs using the first set of antennas. In some aspects, the offset in time can be a cyclic shift diversity (CSD) value applied between the first set of antennas and the second set of antennas.

Another innovative aspect of the subject matter described in this disclosure can be implemented as a method for performing a ranging operation between wireless devices. The method can include receiving, from a wireless device, a frame requesting a length of packet extensions to be used for the ranging operation; selecting a number of long training fields (LTFs) based, at least in part, on the requested packet extension length; and transmitting, to the wireless device, a high efficiency (HE) packet including a packet extension containing the selected number of LTFs. The method also can include receiving, from the wireless device, a feedback frame including estimated angle of departure (AoD) information or angle of arrival (AoA) information of the HE packet. In some aspects, the number of LTFs can be selected by determining a number of antennas from which to transmit the HE packet extension and determining a number of spatial streams upon which to transmit the packet extension, wherein the selected number of LTFs is further based on at least one of the determined number of antennas, the determined number of spatial streams, and a size or duration of the LTFs.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a block diagram of an example wireless system.

FIG. 2 shows a block diagram of an example wireless device.

FIG. 3 shows a signal diagram of an example ranging operation.

FIG. 4 shows a signal diagram of another example ranging operation.

FIG. 5A shows a signal diagram of an example ranging operation.

FIG. 5B shows a signal diagram depicting TOD and TOA values of individual long training fields (LTFs) of the example ranging operation of FIG. 5A.

FIG. 5C shows a sequence diagram depicting the example ranging operation of FIG. 5A.

FIG. 6A shows an example table indicating the number and orthogonality of sounding LTFs that may be contained within high efficiency (HE) packet extensions.

FIG. 6B shows an illustration depicting an example transmission of a packet extension containing sounding LTFs.

FIGS. 6C(1) and 6C(2) show a table including a number of example packet extension configurations.

FIG. 7A shows a flow chart depicting an example ranging operation.

FIG. 7B shows a flow chart depicting an example operation for determining whether an HE packet extension contains sounding LTFs.

FIG. 7C shows a flow chart depicting another example ranging operation.

FIG. 7D shows a flow chart depicting another example ranging operation.

FIG. 8 shows an illustration depicting a wireless device processing a received HE packet extension.

FIG. 9A shows an example packet.

FIG. 9B shows an example high efficiency (HE) preamble.

FIG. 10A shows an example fine timing measurement (FTM) request frame.

FIG. 10B shows an example FTM action frame.

FIG. 11 shows an example vendor-specific information element (VSIE).

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals according to any of the IEEE 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

Implementations of the subject matter described in this disclosure may allow wireless devices to indicate or to detect the presence of sounding sequences contained in (or transmitted with) packets or frames exchanged during ranging operations on a per-packet basis. In some implementations, a first wireless device can transmit, to a second wireless device, a frame requesting a length of packet extensions to be used for a ranging operation. The second wireless device can transmit, to the first wireless device, a high efficiency (HE) packet including a packet extension that contains a selected number of sounding long training fields (LTFs). The second wireless device can select the number of sounding LTFs based on one or more of the requested packet extension length, the number of antennas used to transmit the packet extension, the number of spatial streams used to transmit the packet extension, and the size or duration of the sounding LTFs. In some implementations, the HE packet can include a field indicating at least one of the number of antennas used to transmit the packet extension, the number of spatial streams used to transmit the packet extension, the length of the packet extension, and the size or duration of the sounding LTFs. The first wireless device can perform the ranging operation with the second wireless device based on a determination that the packet extension contains sounding LTFs. In some implementations, the first wireless device can determine whether the packet extension of an HE packet contains sounding LTFs by detecting, in a preamble of the HE packet, a bit indicating that the packet extension contains sounding LTFs. In some other implementations, the first wireless device can determine whether the packet extension of an HE packet contains sounding LTFs by extracting patterns from the packet extension and correlating the extracted patterns with a number of reference sequences. In this manner, the first wireless device can determine whether the packet extensions of HE packets contain sounding LTFs on a per-packet basis.

Particular implementations of the subject matter described in this disclosure can be implemented to realize one or more of the following potential advantages. Although a wireless device may be configured to estimate angle information or to estimate channel conditions based on all received packets, the power consumption and degree of resource utilization associated with such a configuration may be unacceptable. The ability of a wireless device to determine whether packet extensions of HE packets contain sounding LTFs from which angle information may be estimated or derived on a per-packet basis may reduce power consumption and the degree of resource utilization of the wireless device without adversely impacting performance. For example, if the packet extension of an HE packet contains sounding LTFs, the wireless device may enable a number of circuits or may begin executing a number of software programs to estimate angle information of the HE packet (or to estimate channel conditions from which the angle information may be derived). Conversely, if the packet extension of the HE packet does not contain sounding LTFs, the wireless device may not enable the number of circuits or begin executing the number of software programs, thereby reducing power consumption and resource utilization.

Additionally, the ability to estimate angle information based on sounding LTFs contained in the packet extensions of HE packets may allow the wireless device to determine an angular orientation (such as a line of bearing) with respect to another wireless device during a ranging operation. The determined angular orientation may be used in conjunction with round-trip time (RTT) values obtained during the ranging operation to determine the position of the wireless device relative to the other wireless device. In this manner, the wireless device may determine its position without ranging additional wireless devices.

As used herein, the term “timing information” may refer to a difference in time between a time of departure (TOD) of one frame from a given device and a time of arrival (TOA) of another frame at the given device, and the term “angle information” may refer to information indicating a direction of one device relative to another device or to information from which the direction of one device relative to another device may be derived. In some aspects, the term “angle information” may include angle of arrival (AoA) information and angle of departure (AoD) information.

Further, as used herein, the term “HT” may refer to a high throughput frame format or protocol defined, for example, by the IEEE 802.11n standards; the term “VHT” may refer to a very high throughput frame format or protocol defined, for example, by the IEEE 802.11ac standards; the term “HE” may refer to a high efficiency frame format or protocol defined, for example, by the IEEE 802.11ax standards; and the term “non-HT” may refer to a legacy frame format or protocol defined, for example, by the IEEE 802.11a/g standards. Thus, the terms “legacy” and “non-HT” may be used interchangeably herein. Further, as used herein, the term “legacy ACK frame format” may refer to an ACK frame format defined by the IEEE 802.11a/g standards, and the term “non-legacy ACK frame format” may refer to an ACK frame format defined by the IEEE 802.11n/ac/ax standards and to high throughput ACK frame formats that may be defined in one or more future IEEE 802.11 standards.

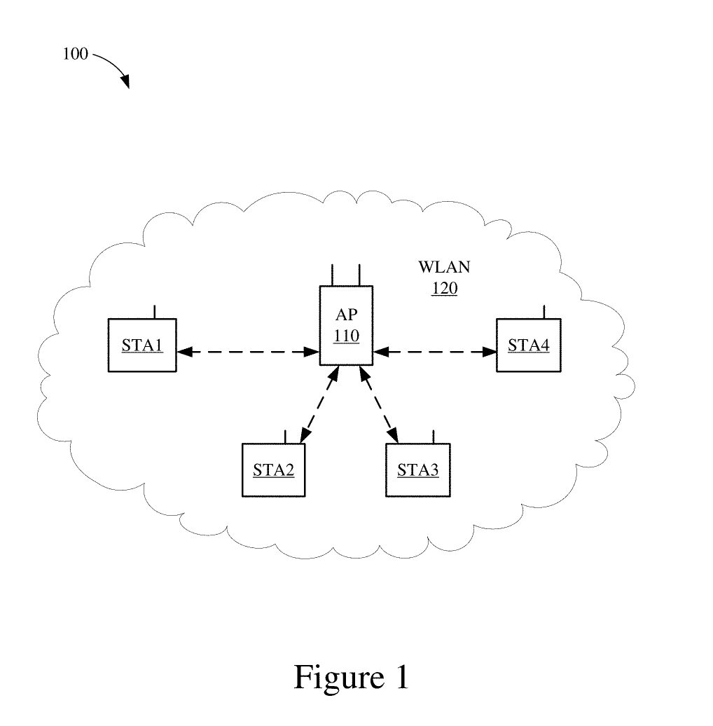

FIG. 1 shows a block diagram of an example wireless system 100. The wireless system 100 is shown to include four wireless stations STA1-STA4, a wireless access point (AP) 110, and a wireless local area network (WLAN) 120. The WLAN 120 may be formed by a plurality of Wi-Fi access points (APs) that may operate according to the IEEE 802.11 family of standards (or according to other suitable wireless protocols). Thus, although only one AP 110 is shown in FIG. 1 for simplicity, it is to be understood that the WLAN 120 may be formed by any number of access points such as the AP 110. The AP 110 is assigned a unique media access control (MAC) address that is programmed therein by, for example, the manufacturer of the access point. Similarly, each of the stations STA1-STA4 is also assigned a unique MAC address. In some implementations, the wireless system 100 may correspond to a multiple-input multiple-output (MIMO) wireless network, and may support single-user MIMO (SU-MIMO) and multi-user (MU-MIMO) communications. Further, although the WLAN 120 is depicted in FIG. 1 as an infrastructure BSS, in some other implementations, the WLAN 120 may be an IBSS, an ad-hoc network, or a peer-to-peer (P2P) network (such as operating according to the Wi-Fi Direct protocols).

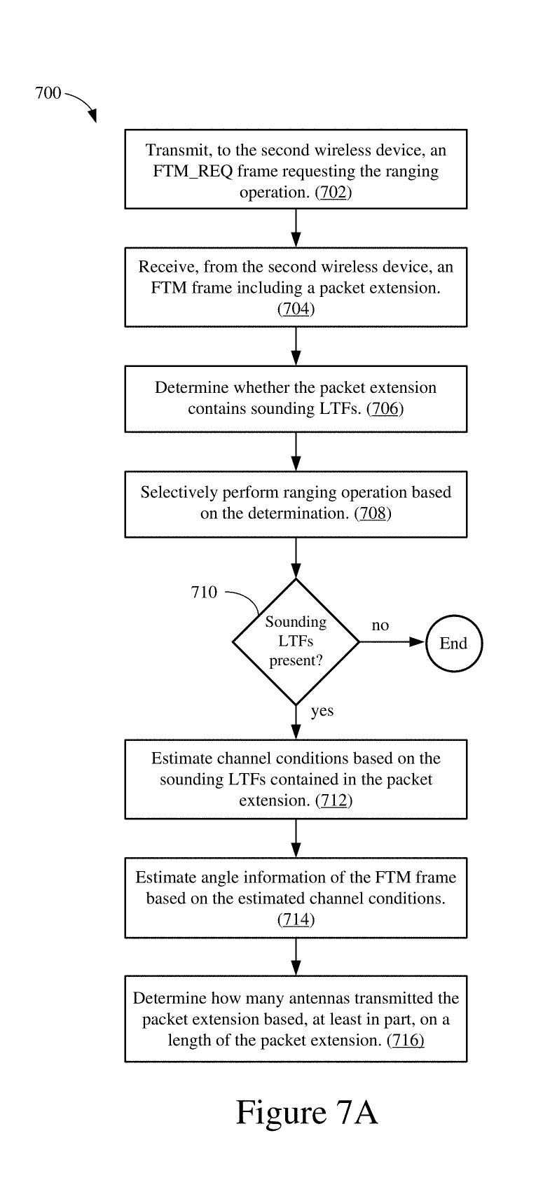

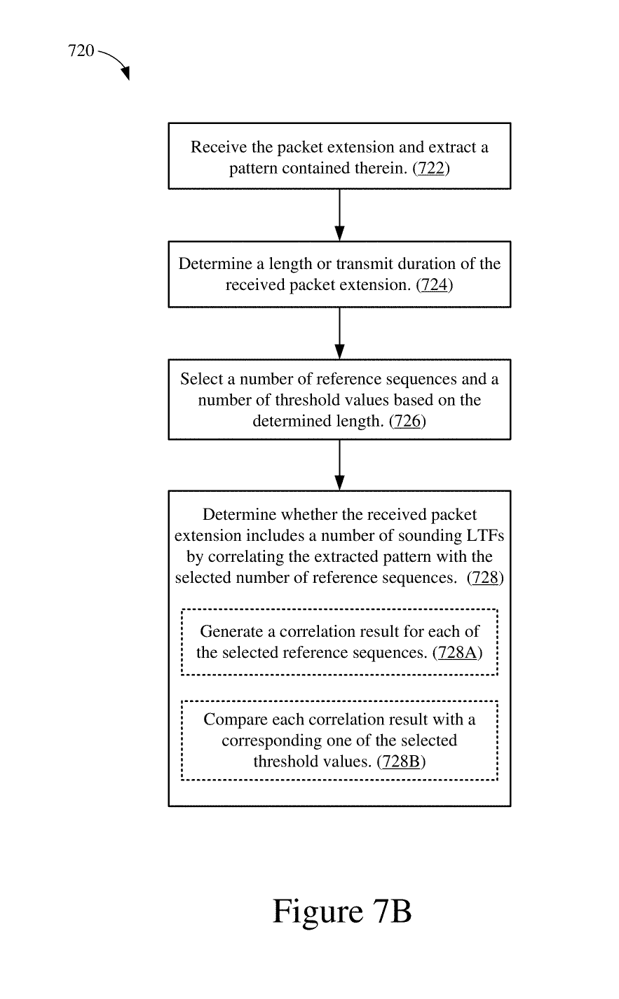

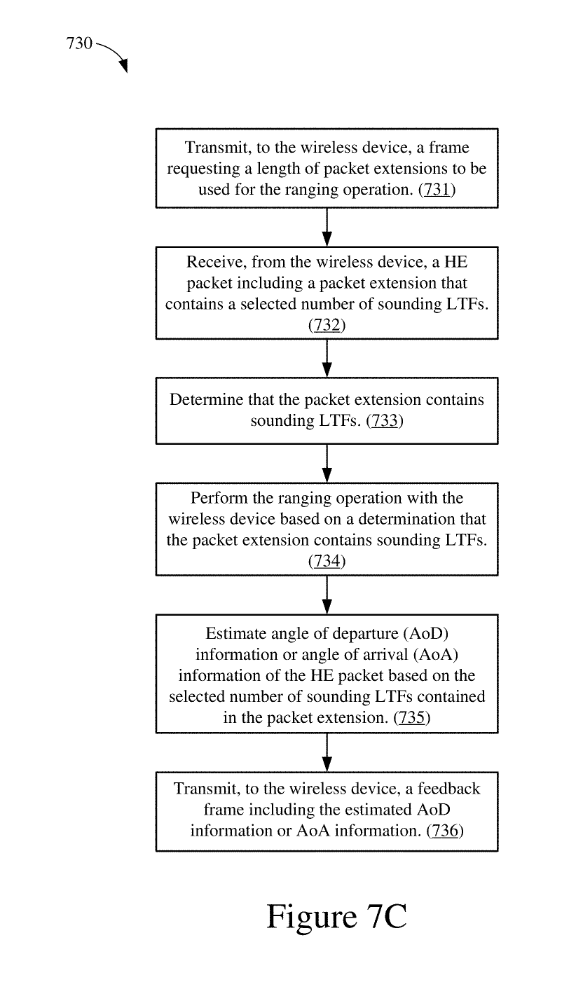

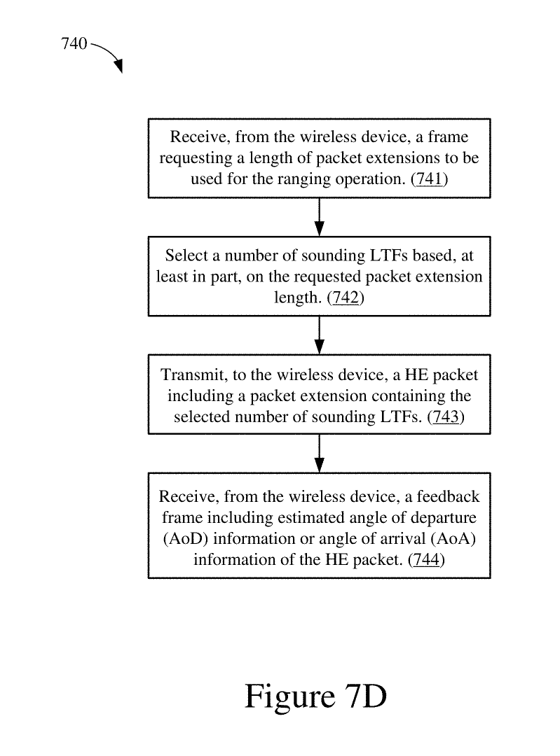

Each of the stations STA1-STA4 may be any suitable Wi-Fi enabled wireless device including, for example, a cell phone, personal digital assistant (PDA), tablet device, laptop computer, or the like. Each of the stations STA1-STA4 also may be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some implementations, each of the stations STA1-STA4 may include one or more transceivers, one or more processing resources (such as processors, ASICs, or a combination of both), one or more memory resources, and a power source (such as a battery). The memory resources may include a non-transitory computer-readable medium (such as one or more nonvolatile memory elements, such as EPROM, EEPROM, Flash memory, a hard drive, etc.) that stores instructions for performing operations described with respect to FIGS. 7A-7D.

The AP 110 may be any suitable device that allows one or more wireless devices to connect to a network (such as a local area network (LAN), wide area network (WAN), metropolitan area network (MAN), and the Internet) via the AP 110 using Wi-Fi, Bluetooth, or any other suitable wireless communication standards. In some implementations, the AP 110 may include one or more transceivers, one or more processing resources (such as processors, ASICs, or a combination of both), one or more memory resources, and a power source. The memory resources may include a non-transitory computer-readable medium (such as one or more nonvolatile memory elements, such as EPROM, EEPROM, Flash memory, a hard drive, etc.) that stores instructions for performing operations described with respect to FIGS. 7A-7D.

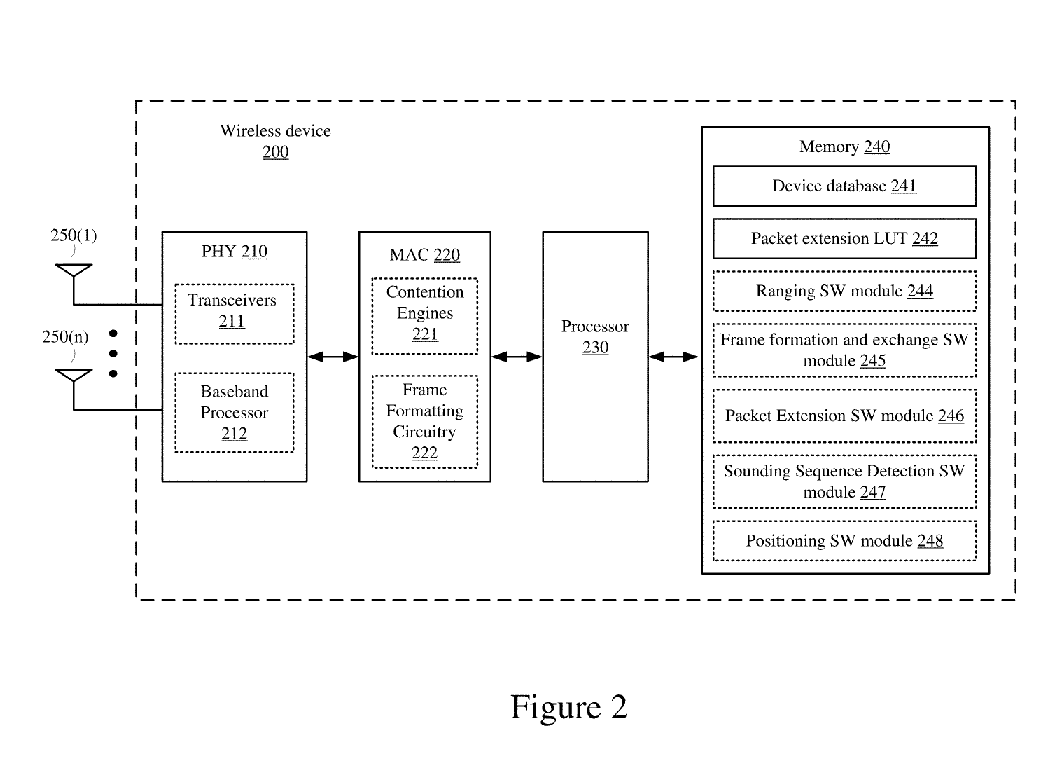

FIG. 2 shows a block diagram of an example wireless device 200. The wireless device 200 may be one implementation of the stations STA1-STA4 of FIG. 1, may be one implementations of the AP 110 of FIG. 1, or both. The wireless device 200 may include at least a physical-layer device (PHY) 210, a medium access controller (MAC) 220, a processor 230, a memory 240, and a number of antennas 250(1)-250(n). The PHY 210 may include at least a number of transceivers 211 and a baseband processor 212. The transceivers 211 may be coupled to antennas 250(1)-250(n), either directly or through an antenna selection circuit (not shown for simplicity). The transceivers 211 may be used to transmit signals to and receive signals from other wireless devices, and may be used to scan the surrounding environment to detect and identify other nearby wireless devices (such as within wireless range of the wireless device 200). Although not shown in FIG. 2 for simplicity, the transceivers 211 may include any number of transmit chains to process and transmit signals to other wireless devices via the antennas 250(1)-250(n), and may include any number of receive chains to process signals received from the antennas 250(1)-250(n). In some implementations, the wireless device 200 may be configured for MIMO operations. The MIMO operations may include SU-MIMO operations and MU-MIMO operations.

The baseband processor 212 may be used to process signals received from the processor 230 and the memory 240 and to forward the processed signals to the transceivers 211 for transmission via one or more of the antennas 250(1)-250(n), and may be used to process signals received from one or more of the antennas 250(1)-250(n) via the transceivers 211 and to forward the processed signals to the processor 230 and the memory 240.

The MAC 220 may include at least a number of contention engines 221 and frame formatting circuitry 222. The contention engines 221 may contend for access to one or more shared wireless mediums, and also may store packets for transmission over the one or more shared wireless mediums. In some other implementations, the contention engines 221 may be separate from the MAC 220. In still other implementations, the contention engines 221 may be implemented as one or more software modules (such as stored in the memory 240 or stored in memory provided within the MAC 220) containing instructions that, when executed by the processor 230, perform the functions of the contention engines 221.

The frame formatting circuitry 222 may be used to create and format frames received from the processor 230 and the memory 240 (such as by adding MAC headers to PDUs provided by the processor 230), and may be used to re-format frames received from the PHY 210 (such as by stripping MAC headers from frames received from the PHY 210). In some aspects, the frame formatting circuitry 222 may be used to append a packet extension to packets to be transmitted from the wireless device 200. More specifically, one or more long training fields (LTFs), such as high efficiency long training fields (HE-LTFs), may be included within a packet extension that is appended to a packet (such as an HE packet). The packet, which may contain an encapsulated fine timing measurement (FTM) frame or an acknowledgement (ACK) frame, may then be used for ranging operations with another wireless device.

The memory 240 may include a device database 241 that may store location data, configuration information, data rates, MAC addresses, and other suitable information about (or pertaining to) a number of access points, stations, and other wireless devices. The device database 241 also may store profile information for a number of wireless devices. The profile information for a given wireless device may include information including, for example, the wireless device's service set identification (SSID), channel information, received signal strength indicator (RSSI) values, goodput values, channel state information (CSI), HE capabilities, angle information estimation capabilities, and connection history with the wireless device 200.

The memory 240 may include a packet extension look-up table (LUT) 242 to store a number of reference sequences and packet extension configuration information. The reference sequences, which may include one or more known sounding sequences (such as LTFs, HT-LTFs, VHT-LTFs, HE-LTFs, or HE-NDPs) expected to be received from other wireless devices during ranging operations, may be used by the wireless device 200 to detect the presence of sounding LTFs in HE packet extensions received from other wireless devices. The packet extension configuration information may indicate various sounding LTF configurations used during ranging operations disclosed herein.

In some implementations, the packet extension LUT 242 may store an LTF-mapping matrix (also referred to herein as a P-matrix) indicating the number and orthogonality of sounding LTFs to be used for ranging operations as a function of the HE packet extension length, the number of antennas (Ntx) used to transmit the HE packet extension, the number of spatial streams (Nsts) used to transmit the HE packet extension, the size or duration of the sounding LTFs, or any combination thereof. The wireless device 200 may use the LTF-mapping matrix, the reference sequences, and the packet extension configuration information to determine whether a received HE packet extension contains one or more sounding LTFs from which channel conditions or angle information may be estimated. In some aspects, the wireless device 200 also may use the LTF-mapping matrix, the reference sequences, and the packet extension configuration information to determine how many antennas were used to transmit the HE packet extension.

The memory 240 also may include a non-transitory computer-readable medium (such as one or more nonvolatile memory elements, such as EPROM, EEPROM, Flash memory, a hard drive, and so on) that may store the following software (SW) modules:
a ranging SW module 244 to capture timestamps of signals received by the wireless device 200 (such as TOA information), to capture timestamps of signals transmitted from the wireless device 200 (such as TOD information), to determine angle of arrival (AoA) information of signals received by the wireless device 200, and to determine angle of departure (AoD) information of signals transmitted from another wireless device, for example, as described for one or more operations of FIGS. 7A-7D;
a frame formation and exchange SW module 245 to create, transmit, and receive frames to and from other wireless devices, to embed TOA information, TOD information, AoA information, and AoD information into selected frames or packets, and to create HE packets that may be used for example ranging operations disclosed herein, for example, as described for one or more operations of FIGS. 7A-7D;
a packet extension SW module 246 to embed one or more sounding LTFs into packet extensions of HE packets and to decode sounding LTFs contained in packet extensions of received HE packets, for example, as described for one or more operations of FIGS. 7A-7D;
a sounding sequence detection SW module 247 to indicate or detect the presence of one or more sounding sequences (such as sounding LTFs) contained in packet extensions of HE packets, for example, as described for one or more operations of FIGS. 7A-7D; and
a positioning SW module 248 to determine the location of the wireless device 200 based, at least in part, on the distances or angle information (or both) determined by the ranging SW module 244, for example, as described for one or more operations of FIGS. 7A-7D.
   Each software module includes instructions that, when executed by the processor 230, cause the wireless device 200 to perform the corresponding functions. The non-transitory computer-readable medium of the memory 240 thus includes instructions for performing all or a portion of the operations of FIGS. 7A-7D.

The processor 230 may be one or more suitable processors capable of executing scripts or instructions of one or more software programs stored in the wireless device 200 (such as within the memory 240). For example, the processor 230 may execute the ranging SW module 244 to capture timestamps of signals received by the wireless device 200 (such as TOA information), to capture timestamps of signals transmitted from the wireless device 200 (such as TOD information), to determine angle of arrival (AoA) information of signals received by the wireless device 200, and to determine angle of departure (AoD) information of signals transmitted from another wireless device.

The processor 230 may execute the frame formation and exchange SW module 245 to create, transmit, and receive frames to and from other wireless devices, to embed TOA information, TOD information, AoA information, and AoD information into selected frames or packets, and to create HE packets that may be used for example ranging operations disclosed herein. Execution of the frame formation and exchange SW module 245 also may be used to encapsulate FTM frames and ACK frames into HE packets.

The processor 230 may execute the packet extension SW module 246 to embed one or more sounding LTFs into packet extensions of HE packets and to decode sounding LTFs contained in packet extensions of received HE packets. Execution of the packet extension SW module 246 also may be used to select a number of sounding LTFs to embed within the packet extension of an HE packet. In some implementations, the number of sounding LTFs may be based on at least one of a requested packet extension length, the number of antennas to be used for transmitting the packet extension, the number of spatial streams upon which the packet extension is to be transmitted, and the size or duration of the sounding LTFs. In some aspects, execution of the packet extension SW module 246 also may retrieve or access an LTF-mapping matrix that can be used to select the number of sounding LTFs to be embedded within the packet extension of an HE packet.

The processor 230 may execute the sounding sequence detection SW module 247 to indicate or detect the presence of one or more sounding sequences (such as sounding LTFs) contained in the packet extensions of HE packets. In some implementations, execution of the sounding sequence detection SW module 247 may provide, within the HE packet, a bit indicating whether the packet extension contains sounding LTFs from which channel conditions or angle information may be estimated. In some other implementations, execution of the sounding sequence detection SW module 247 may be used to detect the indication bit in a received HE packet or to determine whether a received HE packet extension contains sounding LTFs by examining patterns extracted from the received HE packet extension.

The processor 230 may execute the positioning SW module 248 to determine the location of wireless device 200 based, at least in part, on the distances or angle information (or both) determined by the ranging SW module 244.

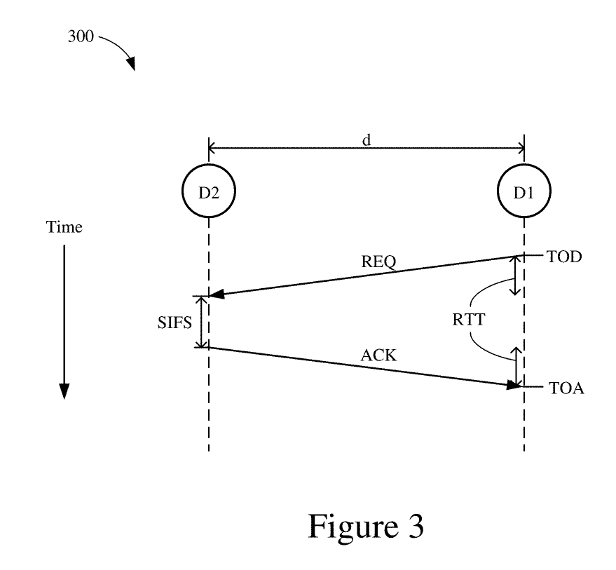

FIG. 3 shows a signal diagram of an example ranging operation 300. The example ranging operation 300 is performed between a first device D1 and a second device D2. The distance (d) between the first device D1 and the second device D2 may be estimated as d=c*RTT/2, where c is the speed of light, and RTT is the summation of the actual signal propagation times of a request (REQ) frame and an acknowledgement (ACK) frame exchanged between the first device D1 and the second device D2. The first device D1 and the second device D2 each may be, for example, an access point (such as the AP 110 of FIG. 1), a station (such as one of the stations STA1-STA4 of FIG. 1), or another suitable wireless device (such as the wireless device 200 of FIG. 2).

The first device D1 may estimate the RTT between itself and the second device D2 using the time of departure (TOD) of the REQ frame transmitted from the first device D1, the time of arrival (TOA) of the ACK frame received by the first device D1, and the short interframe space (SIFS) duration of the second device D2. The SIFS duration may indicate the duration of time between the second device D2 receiving the REQ frame and transmitting the ACK frame. The SIFS duration, a range of values for which are provided by the IEEE 802.11 standards, provides Wi-Fi enabled devices time to switch their transceivers from a receive mode (such as to receive the REQ frame) to a transmit mode (such as to transmit the ACK frame).

Because different make-and-models (and sometimes even same make-and-models) of communication devices have different processing delays, the precise value of SIFS may vary between devices (and even between successive frame receptions/transmissions in the same device). As a result, the value of SIFS is typically estimated, which often leads to errors in estimating the distance between two devices. More specifically, the IEEE 802.11 standards define the SIFS duration as 10 μs+/−900 ns at 2.4 GHz, 16 μs+/−900 ns at 5 GHz, and 3 μs+/−900 ns at 60 GHz. These “standard” SIFS durations include tolerances that may decrease the accuracy of RTT estimates. For example, even if the SIFS duration of device D2 may be estimated within +/−25 ns, a ranging error of +/−7.5 meters may result (which may be unacceptable for many positioning systems). Ranging errors resulting from uncertainties in the value of SIFS may be avoided by capturing timestamps of incoming and outgoing frames, for example, so that the value of RTT may be determined without using SIFS.

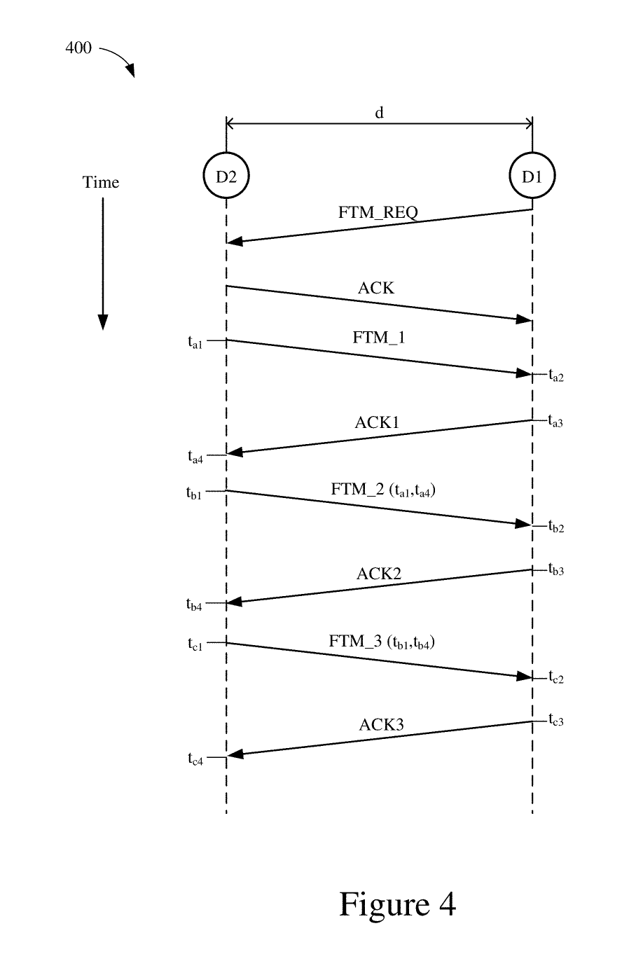

FIG. 4 shows a signal diagram of an example ranging operation 400. The example ranging operation 400 is performed between the first device D1 and the second device D2 using Fine Timing Measurement (FTM) frames in accordance with the IEEE 802.11REVmc standards. The first device D1 and the second device D2 each may be, for example, an access point (such as the AP 110 of FIG. 1), a station (such as one of the stations STA1-STA4 of FIG. 1), or other suitable wireless device (such as the wireless device 200 of FIG. 2). However, it is to be understood that the ranging operation 400 may be performed by any suitable wireless devices including, for example, the AP 110 of FIG. 1, one or more of the stations STA1-STA4 of FIG. 1, or the wireless device 200 of FIG. 2. For the example of FIG. 4, the first device D1 requests the ranging operation; thus, the first device D1 is the initiator device (or alternatively the requestor device) and the second device D2 is the responder device.

The first device D1 may request or initiate the ranging operation 400 by transmitting an FTM request (FTM_REQ) frame to the second device D2. The FTM_REQ frame also may include a request for the second device D2 to capture timestamps (such as TOA information) of received frames and to capture timestamps (such as TOD information) of transmitted frames. The second device D2 receives the FTM_REQ frame, and may acknowledge the requested ranging operation by transmitting an acknowledgement (ACK) frame to the first device D1. The ACK frame may indicate whether the second device D2 is capable of capturing the requested timestamps. The exchange of the FTM_REQ frame and the ACK frame is a handshake process that not only signals an intent to perform a ranging operation but also allows the first device D1 and the second device D2 to determine whether each other supports capturing timestamps.

At time tₐ₁, the second device D2 transmits a first FTM (FTM_1) frame to the first device D1, and may capture the TOD of the FTM_1 frame as time tₐ₁. The first device D1 receives the FTM_1 frame at time tₐ₂, and may capture the TOA of the FTM_1 frame as time tₐ₂. The first device D1 responds by transmitting a first FTM acknowledgement (ACK1) frame to the second device D2 at time to, and may capture the TOD of the ACK1 frame as time tₐ₃. The second device D2 receives the ACK1 frame at time tₐ₄, and may capture the TOA of the ACK1 frame at time tₐ₄. At time t_{b1}, the second device D2 transmits (to the first device D1) a second FTM (FTM_2) frame that includes the timestamps captured at times tₐ₁ and tₐ₄ (such as the TOD of the FTM_1 frame and the TOA of the ACK1 frame). The first device D1 receives the FTM_2 frame at time t_{b2}, and may capture its timestamp as time t_{b2}.

Upon receiving the FTM_2 frame at time t_{b2}, the first device D1 has timestamp values for times tₐ₁, tₐ₂, tₐ₃, and tₐ₄ that correspond to the TOD of the FTM_1 frame transmitted from the second device D2, the TOA of the FTM_1 frame received at the first device D1, the TOD of the ACK1 frame transmitted from the first device D1, and the TOA of the ACK1 frame received at the second device D2, respectively. Thereafter, the first device D1 may determine a first RTT value as RTT₁=(tₐ₄−tₐ₃)+(tₐ₂−tₐ₁). Because the value of RTT₁ does not involve estimating SIFS for either the first device D1 or the second device D2, the value of RTT₁ does not involve errors resulting from uncertainties of SIFS durations, thereby improving the accuracy with which the distance between the first device D1 and the second device D2 may be determined (such as compared to the ranging operation 300 of FIG. 3).

The first device D1 and the second device D2 may exchange an additional pair of FTM and ACK frames from which an additional RTT value may be determined. Specifically, at time t_{b3}, the first device D1 may transmit a second FTM acknowledgement (ACK2) frame to the second device D2 (such as to acknowledge reception of the FTM_2 frame). The second device D2 receives the ACK2 frame at time t_{b4}, and may record the TOA of the ACK2 frame as time t_{b4}. At time t_{c1}, the second device D2 transmits (to the first device D1) a third FTM (FTM_3) frame that includes the timestamps captured at times t_{b1} and t_{b4} (such as the TOD of the FTM_2 frame and the TOA of the ACK2 frame). The first device D1 receives the FTM_3 frame at time t_{c2}, and may capture its timestamp as time t_{c2}. The first device D1 may respond by transmitting a third FTM acknowledgement (ACK3) frame to the second device D2 at time t_{c3}.

Upon receiving the FTM_3 frame at time t_{c2}, the first device D1 has timestamp values for times t_{b1}, t_{b2}, t_{b3}, and t_{b4} that correspond to the TOD of the FTM_2 frame transmitted from the second device D2, the TOA of the FTM_2 frame received at the first device D1, the TOD of the ACK2 frame transmitted from the first device D1, and the TOA of the ACK2 frame received at the second device D2, respectively. Thereafter, the first device D1 may determine a second RTT value as RTT2=(t_{b4}−t_{b3})+(t_{b2}−t_{b1}). This process may continue for any number of subsequent FTM and ACK frame exchanges between the first device D1 and the second device D2, for example, where the second device D2 embeds the timestamps of a given FTM and ACK frame exchange into a subsequent FTM frame transmitted to the first device D1.

The IEEE 802.11REVmc standards allow FTM frames (such as the FTM_1 frame, the FTM_2 frame, and the FTM_3 frame of the example ranging operation 400 of FIG. 4) to be transmitted using the legacy (such as non-HT) format, the HT format, and the VHT format. Although the IEEE 802.11REVmc standards may not specify whether FTM frames may be transmitted using the HE format, the IEEE 802.11REVmc standards specify that ranging operations using FTM frames are to be transmitted using a single antenna of each ranging device (such as to avoid ranging errors resulting from cyclic shift diversity associated with multi-antenna transmissions). However, because packets transmitted using the HE format use more tones than packets transmitted using the HT format or the VHT format, ranging accuracy may be improved by encapsulating at least the FTM frames into HE packets for ranging operations.

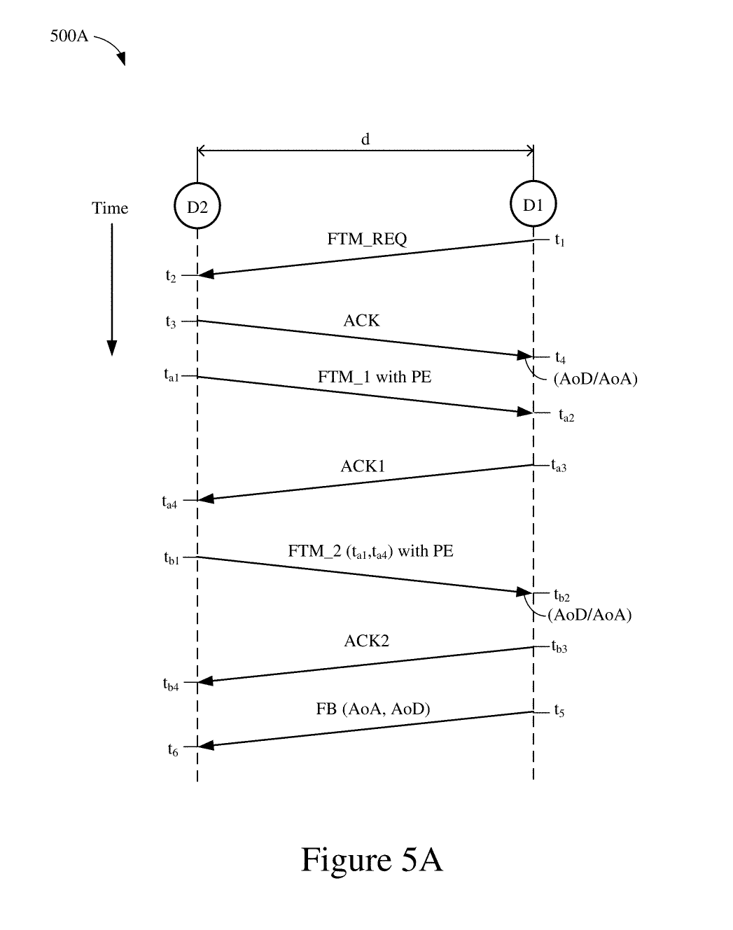

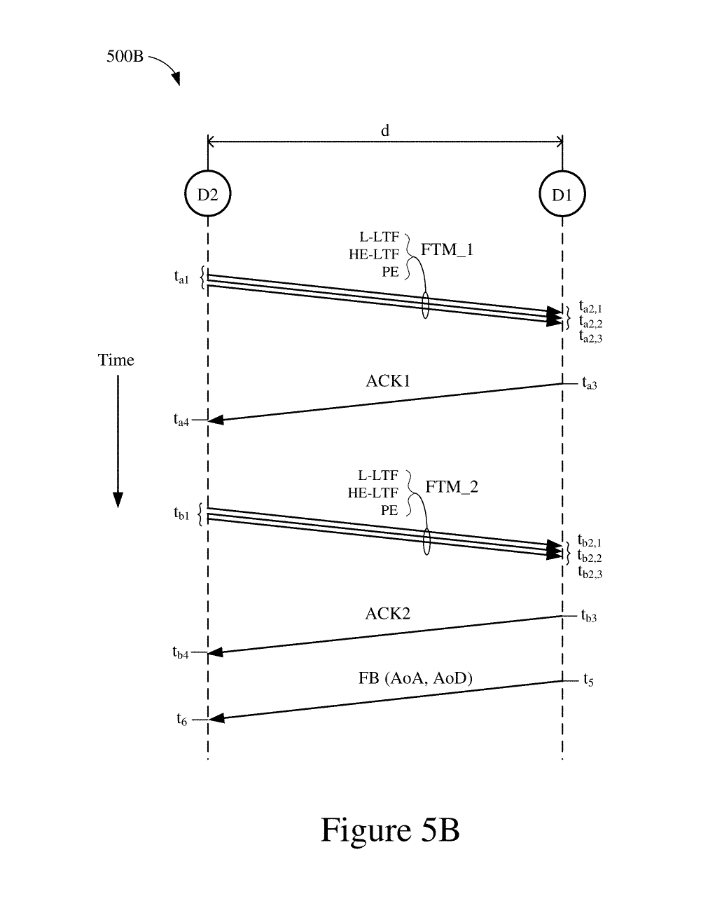

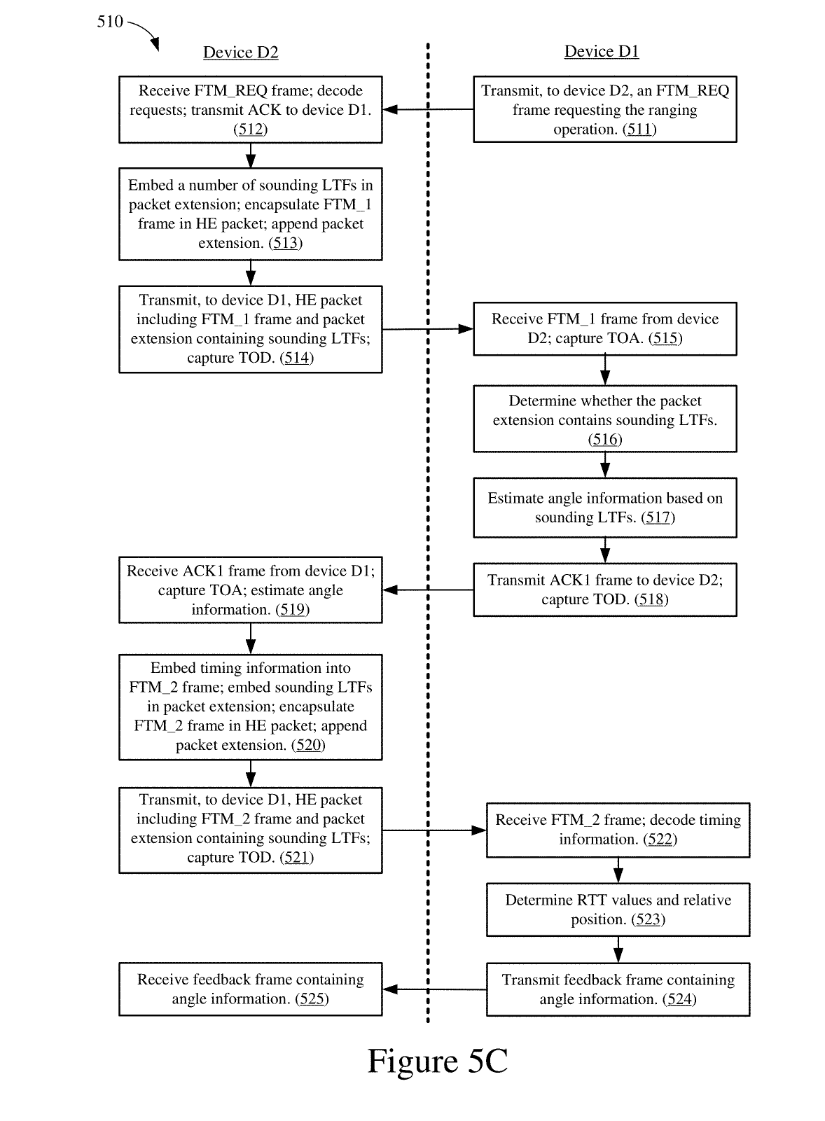

FIG. 5A shows a signal diagram of an example ranging operation 500A, FIG. 5B shows a signal diagram 500B depicting TOA values of individual LTFs of the ranging operation 500A of FIG. 5A, and FIG. 5C shows a sequence diagram 510 depicting the example ranging operation 500A of FIG. 5A. The example ranging operation 500A may be performed between a first device D1 and a second device D2. The first device D1 and the second device D2 each may be, for example, an access point (such as the AP 110 of FIG. 1), a station (such as one of the stations STA1-STA4 of FIG. 1), or another suitable wireless device (such as the wireless device 200 of FIG. 2).

The example ranging operation 500A of FIG. 5A may allow the first device D1 to obtain a plurality of RTT measurements from each exchange of FTM and ACK frames, thereby allowing the first device D1 to simultaneously, or substantially simultaneously, determine a plurality of RTT values indicative of the distance (d) between the first device D1 and the second device D2 from a single FTM/ACK frame exchange. The plurality of RTT values be may combined (such as averaged) to offset noise and erroneous RTT values, for example, to increase ranging accuracy. The example ranging operation 500A of FIG. 5A also may allow the first device D1 to estimate angle information of packets transmitted from the second device D2, which may allow the first device D1 to determine its position relative to the second device D2.

At time t₁, the first device D1 may request or initiate the ranging operation 500A by transmitting an FTM_REQ frame to the second device D2 (511). The FTM_REQ frame also may include a request for the second device D2 to capture timestamps (such as TOA information of frames received by the second device D2 and TOD information of frames transmitted from device D2). In some aspects, the FTM_REQ frame may include a request for the second device D2 to estimate angle information, may include a request for a specified packet extension length for HE packets to be used in the ranging operation 500A, or both.

The second device D2 receives the FTM_REQ frame at time t₂, and may acknowledge the requested ranging operation by transmitting an acknowledgement (ACK) frame to the first device D1 at time t₃ (512). The ACK frame may indicate whether the second device D2 is capable of capturing timestamps, capable of estimating angle information, capable of performing ranging operations using HE packets containing a number of sounding LTFs, or any combination thereof. The first device D1 may receive the ACK frame at time t₄. After this handshake process, the ranging operation between the first device D1 and the second device D2 may begin.

The second device D2 may embed a selected number of sounding LTFs into a packet extension, may encapsulate an FTM_1 frame into an HE packet, and may append the packet extension containing the selected number of sounding LTFs to the HE packet (513). The HE packet may include a preamble containing a legacy long training field (L-LTF) and a high efficiency long training field (HE-LTF), and may include a body containing control information. In some implementations, the second device D2 may select the number of sounding LTFs to be transmitted with the FTM_1 frame based on the packet extension length requested by the first device D1, the number of transmit antennas (Ntx) to be used for transmitting the packet extension, the number of spatial streams (Nsts) upon which the packet extension is to be transmitted, the size or duration of the sounding LTFs, or any combination thereof. In some aspects, the values of Ntx and Nsts may be equal (such as the number of spatial streams equals the number of transmit antennas) if the second device D2 includes four or less transmit antennas, and the values of Ntx and Nsts may not be equal (such as the number of spatial streams is less than the number of transmit antennas) if the second device D2 includes more than four transmit antennas.

At time tₐ₁, the second device D2 may transmit the HE packet including the FTM_1 frame and the packet extension containing the selected number of sounding LTFs to the first device D1, and may capture the TOD of the FTM_1 frame as time tₐ₁ (514). In some aspects, the second device D2 also may configure the L-LTF and the HE-LTF provided in the preamble of the HE packet for RTT measurements. The first device D1 may use the L-LTF and the HE-LTF in the preamble of the HE packet to obtain RTT values for the frame exchange, and may use the number of sounding LTFs contained in the packet extension of the HE packet to obtain additional RTT measurements (such as in addition to the RTT measurements obtained from the L-LTF and the HE-LTF provided in the preamble of the HE packet). The number of sounding LTFs contained in the packet extension of the HE packet also may be used by the first device D1 to estimate or derive angle information of the HE packet which encapsulates the FTM_1 frame.

The first device D1 receives the HE packet which encapsulates the FTM_1 frame at time tₐ₂, and may capture the TOA of the HE packet as time tₐ₂ (515). In some implementations, the first device D1 may capture the TOAs of the L-LTF and HE-LTF in the preamble of the HE packet, and may capture the TOA of the sounding LTFs contained in the packet extension of the HE packet. The L-LTF, the HE-LTF, and the sounding LTFs in the HE packet may have different TOA values. For example, referring also to FIG. 5B, the L-LTF may have a TOA of t_{a2,1}, the HE-LTF may have a TOA of t_{a2,2}, and the sounding LTFs contained in the packet extension of the HE packet may have a TOA of t_{a2,3}. In some aspects, the TOA (tₐ₂) determined by the first device D1 may be based on (such as an average of) the TOAs of the L-LTF, the HE-LTF, and the sounding LTFs received with the HE packet (device D1 may use any suitable algorithm for selecting an accurate TOA value for tₐ₂). In some other aspects, the first device D1 may capture the TOA of the HE packet based on a last bit or symbol of the packet extension being received by the first device D1.

The first device D1 may determine whether the packet extension of the received HE packet contains a number of sounding LTFs (516). In some implementations, a bit in the preamble of the HE packet may be used to indicate the presence of sounding LTFs in the packet extension of the HE packet. This bit, which may be referred to herein as an “LTF indication bit,” may be any suitable bit such as, for example, one of the reserved bits in the preamble of the HE packet. In some aspects, the LTF indication bit may be one of the reserved or otherwise unused bits in one of the signaling fields (such as the SIG-A1 and SIG-A2 fields) in the preamble of the HE packet. If modification of the packet preamble to include the LTF indication bit is defined by the IEEE 802.11ax standards, then wireless devices may be configured to provide LTF indication bits in the preambles of transmitted HE packets and to decode LTF indication bits in the preambles of received HE packets. In this manner, wireless devices may inform each other as to the presence of LTFs (or other sounding sequences) in the packet extensions of HE packets on a packet-by-packet basis.

In some other implementations, the first device D1 may determine a presence of sounding LTFs in the packet extension of an HE packet by analyzing the patterns or sequences contained therein. In some aspects, the first device D1 may compare patterns extracted from the received HE packet extension with a number of reference sequences to determine whether the HE packet extension contains a number of sounding LTFs from which channel conditions or angle information may be estimated. For example, the first device D1 may determine a degree of correlation between the extracted patterns and the reference sequences, may compare the determined degree of correlation with one or more threshold values, and may determine whether the extracted patterns are sounding LTFs based on the comparison. In this manner, the first device D1 may determine the presence of sounding LTFs in HE packet extensions on a per-packet basis without using a dedicated bit in the preamble of HE packets (or other special signaling techniques).

The first device D1 may determine whether to perform the ranging operation 500A with the second device D2 based on the presence of sounding LTFs in the packet extension of the HE packet. For example, if the first device D1 determines that the HE packet extension contains a number of sounding LTFs, then the first device D1 may process the received sounding LTFs to estimate channel conditions between the first device D1 and the second device D2 or to estimate angle information of the received HE packet. Conversely, if the first device D1 determines that the HE packet extension does not contain any sounding LTFs (but rather contains only padding), then the first device D1 may ignore the HE packet extension and thereby avoid power consumption associated with estimating MIMO channel conditions or angle information.

For the example ranging operation 500A of FIG. 5A, the packet extension of the HE packet which encapsulates the FTM_1 frame contains a number of sounding LTFs. In response thereto, the first device D1 may process the number of sounding LTFs to estimate or derive angle information of the HE packet (517). In some implementations, the first device D1 may use the sounding LTFs to estimate MIMO channel conditions between the first device D1 and the second device D2, and then derive angle information of the HE packet from the estimated MIMO channel conditions, for example, using any suitable technique or algorithm.

In some other implementations, the first device D1 may estimate angle information of the HE packet based on phase differences between signal components of the HE packet arriving at the first device D1. For example, if the second device D2 uses multiple antennas to transmit the packet extension, the first device D1 may estimate AoD information of the HE packet based on phase differences between signal components of the packet extension transmitted from the multiple antennas of the second device D2. For another example, if the first device D1 uses multiple antennas to receive the packet extension, the first device D1 may estimate AoA information of the HE packet based on phase differences between signal components of the packet extension arriving at the multiple antennas of the first device D1.

At time tₐ₃, the first device D1 may transmit an ACK1 frame to the second device D2, and may capture the TOD of the ACK1 frame as time to (518). Although not shown in FIGS. 5A-5C for simplicity, in some other implementations, the ACK1 frame may be encapsulated in an HE packet. In some aspects, the preamble of the HE packet which encapsulates the ACK1 frame may include an L-LTF and an HE-LTF from which the second device D2 may obtain TOA values. The HE packet which encapsulates the ACK1 frame also may include a packet extension containing a number of sounding LTFs, for example, so that the second device D2 may estimate angle information of the ACK1 frame and obtain additional TOA values associated with the ACK1 frame.

The second device D2 may receive the ACK1 frame at time tₐ₄, may capture the TOA of the ACK1 frame as time tₐ₄, and may estimate angle information (such as AoD information or AoA information) of the ACK1 frame (such as if the ACK1 frame is transmitted from the first device D1 with a packet extension including a number of sounding LTFs) (519). The second device D2 may embed timing information into an FTM_2 frame, embed a number of sounding LTFs into a packet extension, encapsulate the FTM_2 frame into an HE packet, and append the packet extension containing the number of sounding LTFs to the HE packet (520). The timing information may indicate the TOD of the FTM_1 frame (time tₐ₁) and the TOA of the ACK1 frame (time tₐ₄). In some aspects, the second device D2 also may embed, into the FTM_2 frame, angle information estimated for frames received from the first device D1.

At time t_{b1}, the second device D2 may transmit the HE packet which encapsulates the FTM_2 frame and includes the packet extension containing the sounding LTFs to the first device D1, and may capture the TOD of the FTM_2 frame as time t_{b1} (521). In some aspects, the second device D2 also may configure the L-LTF and the HE-LTF of the preamble of the HE packet for RTT measurements. The number of sounding LTFs contained in the packet extension of the HE packet may be used by the first device D1 to obtain additional RTT measurements (such as in addition to RTT measurements obtained from the L-LTF and the HE-LTF of the preamble of the HE packet). The number of sounding LTFs contained in the packet extension of the HE packet also may be used by the first device D1 to estimate angle information of the HE packet.

The first device D1 receives the HE packet which encapsulates the FTM_2 frame at time t_{b2}, and decodes the timing information embedded therein (522). The first device D1 may capture the TOA of the HE packet which encapsulates the FTM_2 frame as time t_{b2}. In some implementations, the first device D1 may capture the TOAs of the L-LTF and HE-LTF in the preamble of the HE packet, and may capture the TOA of the sounding LTFs contained in the packet extension of the HE packet. The L-LTF, the HE-LTF, and the sounding LTFs in the HE packet may have different TOA values. For example, referring also to FIG. 5B, the L-LTF may have a TOA of t_{b2,1}, the HE-LTF may have a TOA of t_{b2,2}, and the sounding LTFs contained in the packet extension of the HE packet may have a TOA of t_{b2,3}. In some aspects, the TOA (t_{b2}) determined by the first device D1 may be based on (such as an average of) the TOAs of the L-LTF, the HE-LTF, and the sounding LTFs received with the HE packet which encapsulates the FTM_2 frame (the first device D1 may use any suitable algorithm for selecting an accurate TOA value for t_{b2}). In some other aspects, the first device D1 may capture the TOA of the HE packet which encapsulates the FTM_2 frame based on a last bit or symbol of the packet extension of the HE packet being received by the first device D1.

The first device D1 also may estimate angle information (such as AoD information or AoA information) of the HE packet which encapsulates the FTM_2 frame based on the sounding LTFs contained in the packet extension of the HE packet.

Upon receiving the HE packet which encapsulates the FTM_2 frame at time t_{b2}, the first device D1 has a timestamp value for time tₐ₁ that corresponds to the TOD of the HE packet which encapsulates the FTM_1 frame transmitted from the second device D2, has timestamp values for times t_{a2,1}-t_{a2,3} that correspond to the TOAs of the L-LTF, the HE-LTF, and the sounding LTFs in the HE packet which encapsulates the FTM_1 frame received at the first device D1, has a timestamp value for time tₐ₃ that corresponds to the TOD of the ACK1 frame transmitted from the first device D1, and has a timestamp value for time tₐ₄ that corresponds to the TOA of the ACK1 frame at the second device D2.

Thereafter, the first device D1 may determine a plurality of RTT values based on the timestamp values tₐ₁, t_{a2,1}-t_{a2,3}, tₐ₁, and tₐ₄ and may determine its position relative to the second device D2 using the estimated angle information (523). More specifically, the first device D1 may determine a first RTT value based on the exchange of the L-LTF in the HE packet which encapsulates the FTM_1 frame and the ACK1 frame as RTT1=(tₐ₄−tₐ₃)+(t_{a2,1}−tₐ₁), may determine a second RTT value based on the exchange of the HE-LTF in the HE packet which encapsulates the FTM_1 frame and the ACK1 frame as RTT2=(tₐ₄−tₐ₃)+(t_{a2,2}−tₐ₁), and may determine a third RTT value based on the exchange of the sounding LTFs appended to the HE packet which encapsulates the FTM_1 frame and the ACK1 frame as RTT3=(tₐ₄−tₐ₃) (t_{a2,3}−tₐ₁).

At time tb₃, the first device D1 may transmit an ACK2 frame to the second device D2, and may capture the TOD of the ACK2 frame as time t_{b3}. Although not shown in FIGS. 5A-5C for simplicity, in some implementations, the ACK2 frame may be encapsulated in an HE packet. In some aspects, the preamble of the HE packet which encapsulates the ACK2 frame may include an L-LTF and an HE-LTF from which the second device D2 may obtain TOA values. The HE packet which encapsulates the ACK2 frame also may include a packet extension containing a number of sounding LTFs, for example, so that the second device D2 may estimate angle information of the ACK2 frame and obtain additional TOA values associated with the ACK2 frame. The second device D2 may receive the ACK2 frame at time t_{b4}, may capture the TOA of the ACK2 frame as time t_{b4}, and may estimate angle information of the ACK2 frame.

Because the first device D1 may estimate the distance to the second device D2 (such as based on the plurality of RTT values) as well as its direction relative to the second device D2 (such as based on angle information of the HE packet which encapsulates the FTM_1 frame), the first device D1 may estimate its location relative to the second device D2. If the actual location of the second device D2 is known, the first device D1 may determine its actual location based on the known location of the second device D2 and its location relative to the second device D2.

At time t₅, the first device D1 may transmit, to the second device D2, a feedback frame containing the estimated angle information (524). The feedback frame may be any suitable frame that can contain the angle information estimated by the first device D1. The second device D2 may receive the feedback frame at time t₆ and retrieve the estimated angle information contained therein (525). In some implementations, the second device D2 may use the estimated angle information contained in the feedback frame to determine its position relative to the first device D1.

Although not shown in FIGS. 5A-5C for simplicity, the first device D1 and the second device D2 may exchange HE capabilities, a capability to estimate channel conditions or angle information based on sounding LTFs contained in packet extensions of HE packets, or both prior to the ranging operation 500A. In some aspects, the first device D1 and the second device D2 may exchange their HE capabilities, their channel estimation capabilities, and their angle information estimation capabilities during an association procedure, for example, by embedding their capabilities into association request and association response frames. In some other aspects, the first device D1 and the second device D2 may exchange their HE capabilities, their channel estimation capabilities, and their angle information estimation capabilities during channel scanning (such as probing) operations, for example, by embedding their capabilities into probe request and probe response frames. In this manner, the first device D1 may be informed that HE packets transmitted from the second device D2 during ranging operations (such as the example ranging operation 500A) may include packet extensions containing a number of sounding LTFs from which angle information may be estimated, and the second device D2 may be informed that the first device D1 is capable of estimating angle information based on sounding LTFs contained in the packet extensions of HE packets.

In some implementations, the first device D1 and the second device D2 each may include a capabilities table that stores the HE capabilities, the channel estimation capabilities, and angle information estimation capabilities for each of a number of wireless devices. The capabilities table may be stored in any suitable memory of the first device D1 or the second device D2. In some aspects, the capabilities table may be stored in the device database 241 of FIG. 2. In this manner, if the first device D1 requests a ranging operation with another device whose HE capabilities are stored in the capabilities table of the first device D1, then the first device D1 may determine whether the other device is capable of transmitting HE packet extensions containing a number of sounding LTFs from which angle information may be derived. Similarly, if the second device D2 performs a ranging operation with another device whose channel estimation capabilities are stored in the capabilities table of the second device D2, the second device D2 may determine whether the other device is capable of estimating angle information based on sounding LTFs contained in the packet extensions of HE packets.

Although described with respect to the FTM protocol, the example ranging operation 500A may be performed using any HE packets which include packet extensions containing one or more sounding LTFs. Thus, the example ranging operations disclosed herein are not limited to FTM ranging operations, but rather may be used in connection with the exchange of any HE packets that encapsulate data frames, control frames, and management frames, for example, as long as the HE packets include packet extensions containing one or more sounding LTFs from which angle information may be estimated or derived.

As described with respect to FIGS. 5A-5C, a wireless device may use a number of sounding LTFs contained in the packet extensions of HE packets to estimate angle information and to obtain additional RTT estimates from each frame exchange of a ranging operation. In some aspects, the second device D2 may select the number and orthogonality of the sounding LTFs contained in HE packet extensions based on the packet extension length requested by the first device D1, the number of antennas (Ntx) used to transmit the HE packet extension, the number of spatial streams (Nsts) used to transmit the HE packet extension, the size or duration of the sounding LTFs, or any combination thereof.

The IEEE 802.11ax standards may allow the packet extension of an HE packet to have a maximum length or transmit duration of 16 μs, and the sounding LTFs may each have a length or transmit duration of 4 μs. Thus, a 16 μs packet extension may include up to four sounding LTFs, a 12 μs packet extension may include up to three sounding LTFs, an 8 μs packet extension may include up to two sounding LTFs, and a 4 μs packet extension may include one sounding LTF. Further, to account for varying numbers of transmit antennas and various HE packet extension lengths, the IEEE 802.11ax standards may specify an LTF-mapping matrix (also denoted herein as a P-matrix), a spatial-mapping matrix (also denoted herein as a Q-matrix), and the sounding sequences to be used for ranging operations based on various transmit antenna configurations and different packet extension lengths.

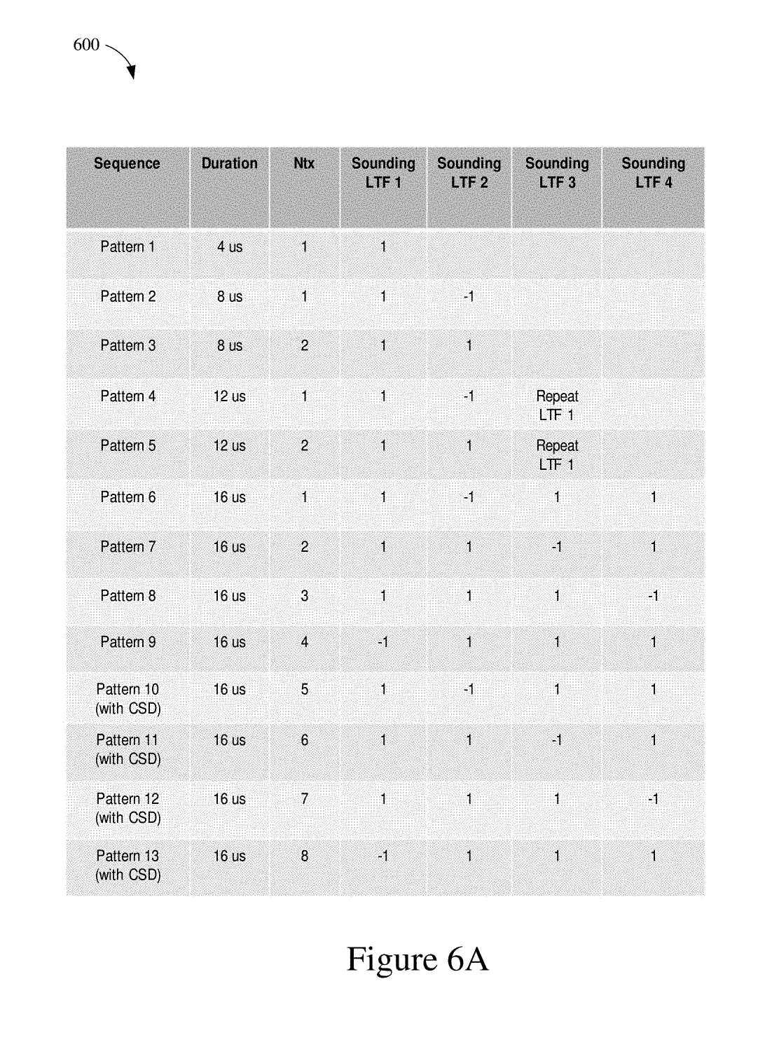

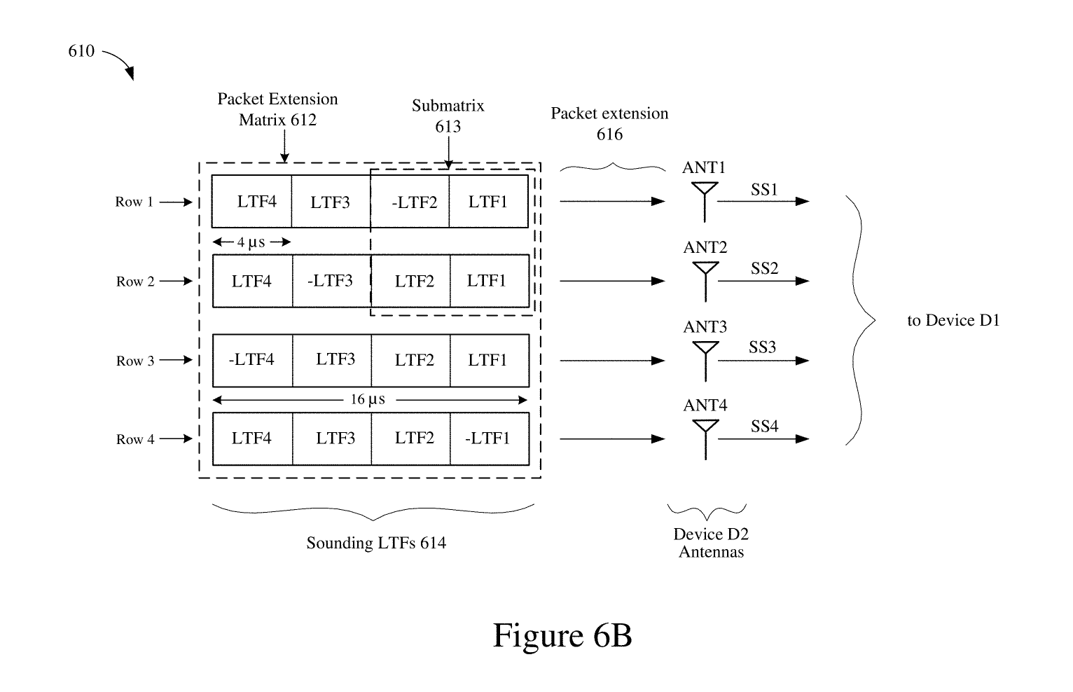

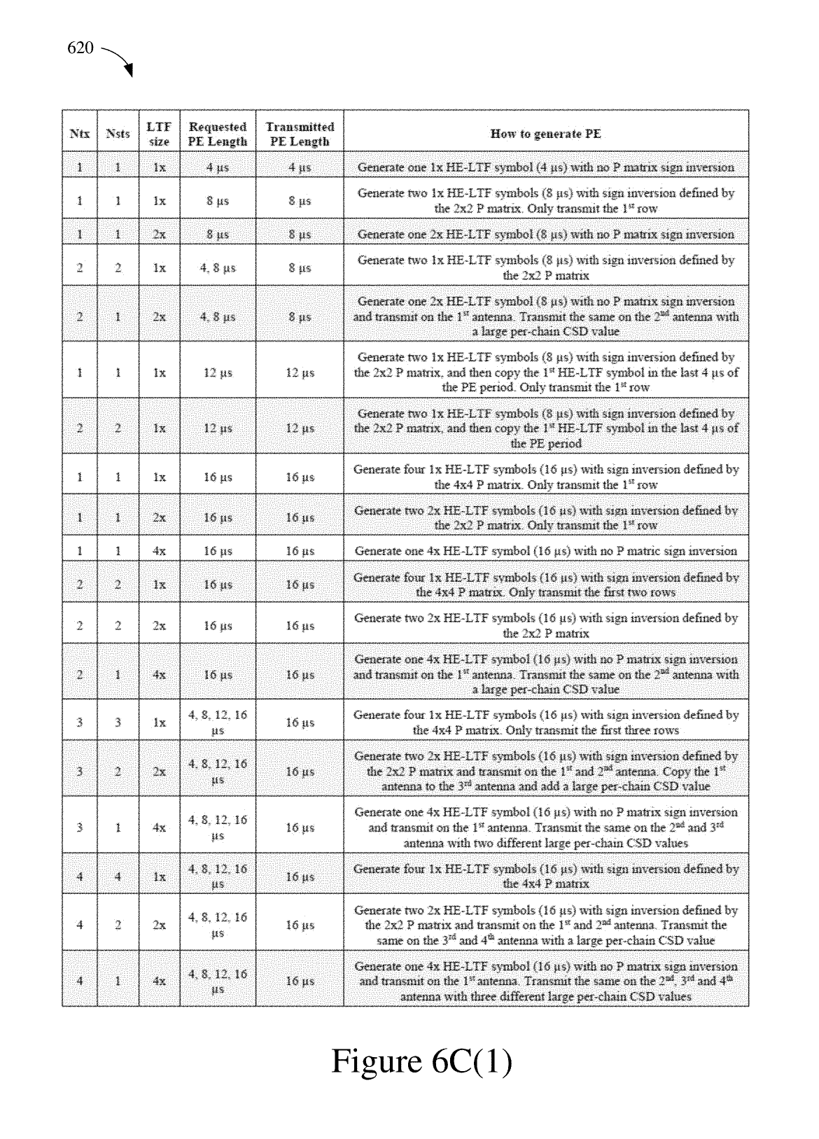

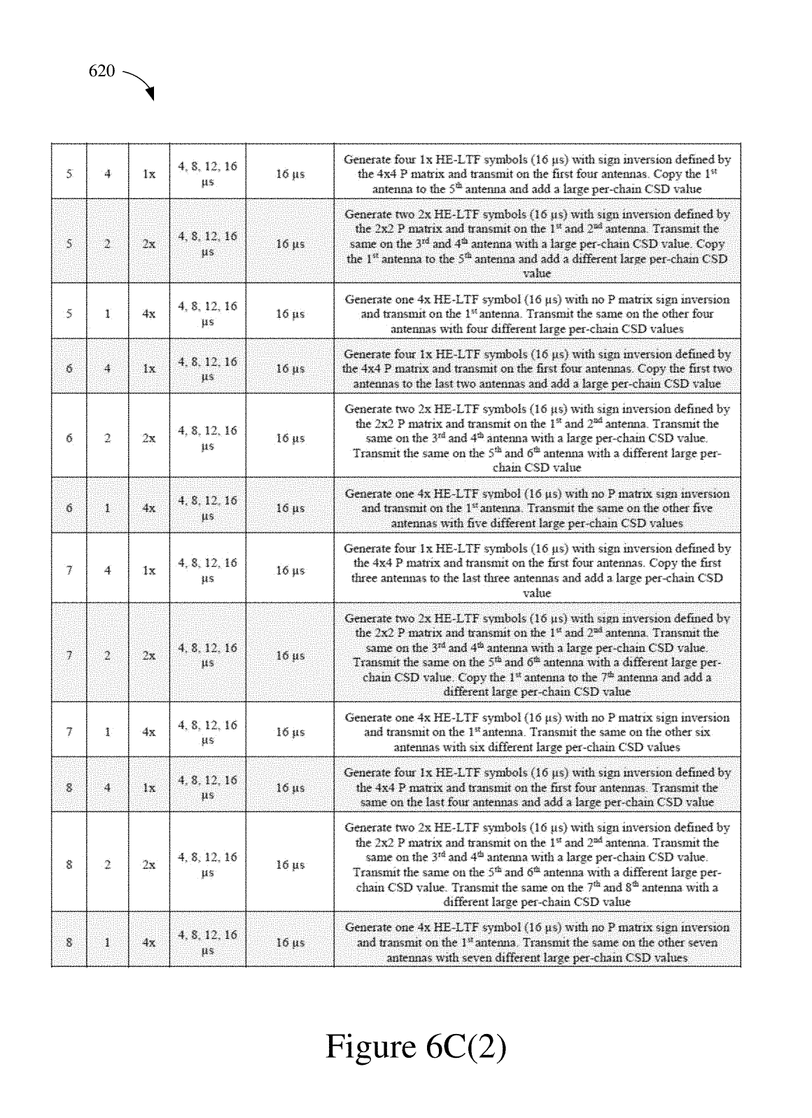

FIG. 6A shows an example table 600 indicating the number and orthogonality of sounding LTFs that may be included within HE packet extensions as a function of packet extension length and the number of transmit antennas. In some aspects, the table 600 may correspond to the LTF-mapping matrix specified by the IEEE 802.11ax standards. A transmitting device may use the table 600 to configure the packet extensions of HE packets transmitted to a receiving device (such as during ranging operations), and the receiving device may use the table 600 to orthogonalize or decode sounding sequences contained in HE packet extensions received during ranging operations. In some implementations, the transmitting device and the receiving device may store the table 600 in a suitable memory (such as in the packet extension LUT 242 of FIG. 2). Although the sounding sequences in the example table 600 are depicted as sounding LTFs, other suitable sounding sequences may be used. Further, in some other implementations, the table 600 depicted in FIG. 6A may be used to configure the sounding sequences contained within (or otherwise associated with) NDPs used in channel sounding operations.

The example table 600 is depicted in FIG. 6A as including thirteen patterns (P1-P13) that may be used by a receiving device to estimate angle information during ranging operations. Each of the 13 patterns P1-P13 may include one or more of four sounding sequences LTF1, LTF2, LTF3, and LTF4 or rotated versions thereof. As used herein, a rotated version of a sounding LTF may be generated using sign inversion, for example, so that the original sounding LTF and the rotated sounding LTF are orthogonal to each other. For example, a rotated version of LTF1 may be denoted as −LTF1, a rotated version of LTF2 may be denoted as −LTF2, a rotated version of LTF3 may be denoted as −LTF3, and a rotated version of LTF4 may be denoted as −LTF4. In addition, each of the sounding sequences LTF1, LTF2, LTF3, and LTF4 may refer or correspond to a four (4) μs slot in an HE packet extension. The use of orthogonal sounding LTFs in HE packet extensions may allow a receiving device to distinguish between sounding LTFs transmitted in different spatial streams (such as by different antennas of the transmitting device).

The first pattern (P1) has a transmit duration of four (4) μs, includes a single sounding sequence (LTF1), and may be used for HE packet extension transmissions from a single antenna. For example, if the transmitting device has a single antenna and the HE packet extension length is 4 μs, then the transmitting device may transmit HE packet extensions containing the single sounding sequence LTF1 using a single antenna. Thus, if a particular HE packet extension has a transmit duration of 4 μs, then the particular HE packet extension can include only one of the sounding sequences LTF1, LTF2, LTF3, and LTF4.

The second pattern (P2) has a transmit duration of eight (8) μs, includes two sounding sequences (LTF1 and −LTF2), and may be used for HE packet extension transmissions from a single antenna. For example, if the transmitting device has a single antenna and the HE packet extension length is 8 μs, then the transmitting device may transmit HE packet extensions containing sounding sequences LTF1 and −LTF2 using a single antenna. Thus, if a particular HE packet extension has a transmit duration of 8 μs, then the particular HE packet extension can include two of the sounding sequences LTF1, LTF2, LTF3, and LTF4.

The third pattern (P3) has a transmit duration of eight (8) μs, includes two sounding sequences (LTF1 and LTF2), and may be used for HE packet extension transmissions using 2 antennas. For example, if the transmitting device has 2 antennas and the HE packet extension length is 8 μs, then the transmitting device may transmit the second pattern (such as containing sounding sequences LTF1 and −LTF2) as a first spatial stream SS1 via a first transmit antenna, and may transmit the third pattern (such as containing sounding sequences LTF1 and LTF2) as a second spatial stream SS2 via a second transmit antenna. In this manner, multiple antennas of the transmitting device may transmit the HE packet extension as multiple spatial streams. Further, because the sounding sequence −LTF2 transmitted via the first spatial stream SS1 is orthogonal to the sounding sequence LTF2 transmitted via the second spatial stream SS2, a receiving device having a single antenna may distinguish between the sounding sequences transmitted from each of the transmit antennas.

The fourth pattern (P4) has a transmit duration of twelve (12) μs, includes three sounding sequences (LTF1, −LTF2, and LTF1), and may be used for HE packet extension transmissions from one antenna. For example, if the transmitting device has a single antenna and the HE packet extension length is 12 μs, then the transmitting device may transmit HE packet extensions containing sounding sequences LTF1, −LTF2, and LTF1 using one antenna. Thus, if a particular HE packet extension has a transmit duration of 12 μs, then the particular HE packet extension can include three of the sounding sequences LTF1, LTF2, LTF3, and LTF4.

The fifth pattern (P5) has a transmit duration of twelve (12) μs, includes three sounding sequences (LTF1, LTF2, and LTF1), and may be used for HE packet extension transmissions using 2 antennas. For example, if the transmitting device has 2 antennas and the HE packet extension length is 12 μs, then the transmitting device may transmit the fourth pattern (such as containing sounding sequences LTF1, −LTF2, and LTF1) as a first spatial stream SS1 via a first transmit antenna, and may transmit the fifth pattern (such as containing sounding sequences LTF1, LTF2, and LTF1) as a second spatial stream SS2 via a second transmit antenna. It is noted that because the sounding sequence-LTF2 transmitted via the first spatial stream SS1 is orthogonal to the sounding sequence LTF2 transmitted via the second spatial stream SS2, a receiving device having a single antenna may distinguish between the sounding sequences transmitted from each of the transmit antennas.

The sixth pattern (P6) has a transmit duration of sixteen (16) μs, includes four sounding sequences (LTF1,-LTF2, LTF3, and LTF4), and may be used for HE packet extension transmissions from a single antenna. For example, if the transmitting device has a single antenna and the HE packet extension length is 16 μs, then the transmitting device may transmit HE packet extensions containing sounding sequences LTF1,-LTF2, LTF3, and LTF4 using one antenna. Thus, if a particular HE packet extension has a transmit duration of 16 μs, the particular HE packet extension can include four of the sounding sequences LTF1, LTF2, LTF3, and LTF4.

The seventh pattern (P7) has a transmit duration of sixteen (16) μs, includes four sounding sequences (LTF1, LTF2,-LTF3, and LTF4), and may be used for HE packet extension transmissions from 2 antennas. For example, if the transmitting device has 2 antennas and the HE packet extension length is 16 μs, then the transmitting device may transmit the sixth pattern (such as containing sounding sequences LTF1,-LTF2, LTF3, and LTF4) as a first spatial stream SS1 via a first transmit antenna, and may transmit the seventh pattern (such as containing sounding sequences LTF1, LTF2, −LTF3, and LTF4) as a second spatial stream SS2 via a second transmit antenna. It is noted that because the sounding sequences −LTF2 and LTF3 transmitted via the first spatial stream SS1 are orthogonal to the sounding sequences LTF2 and −LTF3 transmitted via the second spatial stream SS2, a receiving device having a single antenna may distinguish between the sounding sequences transmitted from each of the transmit antennas.

The eighth pattern (P8) has a transmit duration of sixteen (16) μs, includes four sounding sequences (LTF1, LTF2, LTF3, and −LTF4), and may be used for HE packet extension transmissions from 3 antennas. For example, if the transmitting device has 3 antennas and the HE packet extension length is 16 μs, then the transmitting device may transmit the sixth pattern (such as containing sounding sequences LTF1, −LTF2, LTF3, and LTF4) as a first spatial stream SS1 via a first transmit antenna, may transmit the seventh pattern (such as containing sounding sequences LTF1, LTF2, −LTF3, and LTF4) as a second spatial stream SS2 via a second transmit antenna, and may transmit the eighth pattern (such as containing sounding sequences LTF1, LTF2, LTF3, and −LTF4) as a third spatial stream SS3 via a third transmit antenna. It is noted that the sounding LTFs transmitted via spatial streams SS1-SS3 are orthogonal to one another.

The ninth pattern (P9) has a transmit duration of sixteen (16) μs, includes four sounding sequences (−LTF1, LTF2, LTF3, and LTF4), and may be used for HE packet extension transmissions from 4 antennas. For example, if the transmitting device has 4 antennas and the HE packet extension length is 16 μs, then the transmitting device may transmit the sixth pattern (such as containing sounding sequences LTF1, −LTF2, LTF3, and LTF4) as a first spatial stream SS1 via a first transmit antenna, may transmit the seventh pattern (such as containing sounding sequences LTF1, LTF2, −LTF3, and LTF4) as a second spatial stream SS2 via a second transmit antenna, may transmit the eighth pattern (such as containing sounding sequences LTF1, LTF2, LTF3, and −LTF4) as a third spatial stream SS3 via a third transmit antenna, and may transmit the ninth pattern (such as containing sounding sequences −LTF1, LTF2, LTF3, and LTF4) as a fourth spatial stream SS4 via a fourth transmit antenna. It is noted that the sounding LTFs transmitted via spatial streams SS1-SS4 are orthogonal to one another. In this manner, the receiving device may distinguish between the sounding sequences transmitted from each of the transmit antennas.

The first nine patterns P1-P9 may be used to configure HE packet extensions when the transmitting device includes 4 or less antennas. More specifically, when the transmitting device includes 4 or less antennas, the number of spatial streams upon which the HE packet extension is transmitted may be equal to the number of antennas used to transmit the HE packet extension (such as when Ntx≦4, then Nsts=Ntx).

For at least some implementations, the HE packet extensions are to be transmitted using at most 4 spatial streams. Thus, when the transmitting device includes more than 4 antennas, the first 4 antennas may be used to transmit the HE packet extension as 4 spatial streams SS1-SS4 (such as in a manner similar to that described with respect to pattern (P9)), and any additional antennas may be used to transmit one or more of the same 4 spatial streams SS1-SS4 with a relatively large cyclic shift diversity (CSD) value.

The tenth pattern (P10) has a transmit duration of 16 μs, includes four sounding sequences (LTF1,-LTF2, LTF3, and LTF4), and may be used for HE packet extension transmissions from 5 antennas. For example, if the transmitting device has 5 antennas and the HE packet extension length is 16 μs, then the transmitting device may use four antennas to transmit patterns P6-P9 as 4 spatial streams SS1-SS4 (such as in the manner described with respect to pattern (P9)), and may use the fifth antenna to transmit pattern P10 as another spatial stream having a relatively large CSD with respect to the first four spatial streams SS1-SS4. In some aspects, pattern P10 may be the same as pattern P6, and thus the fifth antenna also may transmit the same pattern as the first antenna, offset in time by the CSD delay between the first and fifth transmit antennas.

The eleventh pattern (P11) has a transmit duration of 16 μs, includes four sounding sequences (LTF1, LTF2,-LTF3, and LTF4), and may be used for HE packet extension transmissions from 6 antennas. For example, if the transmitting device has 6 antennas and the HE packet extension length is 16 μs, then the transmitting device may use four antennas to transmit patterns P6-P9 as 4 spatial streams SS1-SS4 (such as in the manner described with respect to pattern (P9)), and may use the fifth and sixth antennas to transmit patterns P10 and P11 as time-offset versions of patterns P6 and P7 transmitted by the first and second antennas, respectively.

The twelfth pattern (P12) has a transmit duration of 16 μs, includes four sounding sequences (LTF1, LTF2, LTF3, and −LTF4), and may be used for HE packet extension transmissions from 7 antennas. For example, if the transmitting device has 7 antennas and the HE packet extension length is 16 μs, then the transmitting device may use four antennas to transmit patterns P6-P9 as 4 spatial streams SS1-SS4 (such as in the manner described with respect to pattern (P9)), and may use the fifth, sixth, and seventh antennas to transmit patterns P10, P11, and P12 as time-offset versions of patterns P6, P7, and P8 transmitted by the first, second, and third antennas, respectively. In other words, the fifth, sixth, and seventh antennas may transmit the same patterns as the first, second, and third antennas, offset in time by the CSD delay.

The thirteenth pattern (P13) has a transmit duration of 16 μs, includes four sounding sequences (−LTF1, LTF2, LTF3, and LTF4), and may be used for HE packet extension transmissions from 8 antennas. For example, if the transmitting device has 8 antennas and the HE packet extension length is 16 μs, then the transmitting device may use the first four antennas to transmit patterns P6-P9 as 4 spatial streams SS1-SS4 (such as in the manner described with respect to pattern (P9)), and may use the second four antennas to transmit patterns P10-P13 as time-offset versions of patterns P6-P9 transmitted by the first, second, third, and fourth antennas, respectively. In other words, the first four antennas may transmit the same patterns as the second four antennas, offset in time by the CSD delay.

The sounding sequences transmitted by multiple antennas may be separated by code (such as using the P-matrix) and separated in time (such as using CSD). Additional dimensions may be incorporated into the sounding sequences by leveraging CSD values for shorter PE durations. For example, an 8 μs packet extension including 2 LTF symbols may be used to sound 4 antennas. The 4 antennas may be grouped into 2 antenna pairs such that each pair of antennas corresponds with a respective row of a 2-row P-matrix, and the antennas within each pair are further separated by an appropriate CSD value.

FIG. 6B shows an illustration 610 depicting an example transmission of a packet extension 616 containing sounding LTFs 614. For the example illustration 610, a second device D2 having 4 antennas ANT1-ANT4 is depicted transmitting an HE packet extension 616 to a first device D1. The second device D2 may select a number of the sounding LTFs 614 from a packet extension matrix 612. The packet extension 616 has a maximum length of 16 μs, and the sounding LTFs 614 each have a length of 4 μs. Thus, in some aspects, the packet extension 616 may contain up to four sounding LTFs 614. In some other aspects, the packet extension may be of other durations (such as 4 μs, 8 μs, or 12 μs), the sounding LTFs 614 may be of other lengths (such as 8 μs or 16 μs), and the second device D2 may include other numbers of antennas (such as between 1-8 antennas, inclusive).

The second device D2 may transmit the packet extension 616 as 4 spatial streams SS1-SS4 to the first device D1. For example, the first antenna ANT1 may transmit a first spatial stream SS1 to the first device D1, the second antenna ANT2 may transmit a second spatial stream SS2 to the first device D1, the third antenna ANT3 may transmit a third spatial stream SS3 to the first device D1, and the fourth antenna ANT4 may transmit a fourth spatial stream SS4 to the first device D1.

The second device D2 may use the packet extension matrix 612 to select the sounding LTFs 614 for transmission to the first device D1 as four spatial streams SS1-SS4. The packet extension matrix 612 may be stored in any suitable memory device within or accessible by the second device D2 (such as in the packet extension LUT 242 within the memory 240 of FIG. 2). For the example illustration 610 of FIG. 6B, the packet extension matrix 612 is shown as a 4×4 matrix that includes four rows of four sounding LTFs 614. In some aspects, each row of the packet extension matrix 612 may correspond to a respective one of the four antennas ANT1-ANT4 of the second device D2. For example, row 1 of the packet extension matrix 612 is shown to include a first set of four sounding LTFs 614 that may be selected for transmission to the first device D1 as the first spatial stream SS1 via the first antenna ANT1, row 2 of the packet extension matrix 612 is shown to include a second set of four sounding LTFs 614 that may be selected for transmission to the first device D1 as the second spatial stream SS2 via the second antenna ANT2, row 3 of the packet extension matrix 612 is shown to include a third set of four sounding LTFs 614 that may be selected for transmission to the first device D1 as the third spatial stream SS3 via the third antenna ANT3, and row 4 of the packet extension matrix 612 is shown to include a fourth set of four sounding LTFs 614 that may be selected for transmission to the first device D1 as the fourth spatial stream SS4 via the fourth antenna ANT4.

The packet extension matrix 612 may be formed using the four sounding sequences LTF1, LTF2, LTF3, and LTF4 described with respect to FIG. 6A. In some aspects, each row of the packet extension matrix 612 may store various rotations of the four sounding sequences LTF1, LTF2, LTF3, and LTF4, for example, so that each of the spatial streams SS1-SS4 are orthogonal to each other when transmitted from the respective antennas ANT1-ANT4 of the second device D2. For the example of FIG. 6B, row 1 stores four sounding sequences LTF1,-LTF2, LTF3, and LTF4; row 2 stores four sounding sequences LTF1, LTF2,-LTF3, and LTF4; row 3 stores four sounding sequences LTF1, LTF2, LTF3, and −LTF4; and row 4 stores four sounding sequences-LTF1, LTF2, LTF3, and LTF4.

The second device D2 may select the number and orthogonality of the sounding LTFs contained in the packet extension of a HE packet (which may encapsulate an FTM frame) based on the packet extension length requested by the first device D1, the number of transmit antennas (Ntx) used by the second device D2 to transmit the packet extension, the number of spatial streams (Nsts) upon which the packet extension is transmitted, a size or duration of the sounding LTFs, or any combination thereof. In some aspects, the number of rows of the packet extension matrix 612 from which the sounding sequences (such as the sounding LTFs) may be selected for transmission, as well as the total number of sounding LTFs to be selected for transmission, may be based on the number of antennas used to transmit the packet extension, the number of spatial streams upon which the packet extension is to be transmitted, the requested packet extension length, the size or duration of the sounding LTFs, or any combination thereof.

For example, if the second device D2 includes one antenna, then the second device D2 may transmit one spatial stream to the first device D1. In some implementations, the second device D2 may select, from one of the rows of the packet extension matrix 612, a number of sounding LTFs based on the packet extension length requested by the first device D1. If the first device D1 requests a packet extension length of 4 μs, then the second device D2 may transmit a packet extension containing only one sounding sequence to the first device D1 (such as because each of the sounding LTFs 614 has a transmit duration of 4 μs). In some aspects, the second device D2 may select one LTF symbol with no sign inversion for transmission to the first device D1 (such as by transmitting sounding sequence LTF1 as packet extension 616 to the first device D1). If the first device D1 requests a packet extension length of 8 μs, then the second device D2 may transmit a packet extension containing two of the 4 μs-long sounding LTFs 614 to the first device D1. In some aspects, the second device D2 may identify a 2×2 submatrix 613 within the packet extension matrix 612, and then select two LTF symbols with sign inversion for transmission to the first device D1 (such as by transmitting only sounding sequences LTF1 and −LTF2 of row 1 as packet extension 616 to the first device D1). If the first device D1 requests a packet extension length of 16 μs, then the second device D2 may transmit a packet extension containing four of the 4 μs-long sounding LTFs 614 to the first device D1. In some aspects, the second device D2 may select four LTF symbols with sign inversion for transmission to the first device D1 (such as by transmitting sounding sequences LTF1, −LTF2, LTF3, and LTF4 of row 1 as packet extension 616 to the STA).

For another example, if the second device D2 includes two antennas, then the second device D2 may transmit the packet extension 616 as either one spatial stream or two spatial streams to the first device D1. In some implementations, the second device D2 may select a number of sounding LTFs based on the packet extension length requested by the first device D1 and the number of spatial streams upon which the packet extension is to be transmitted. If the second device D2 is to use 2 spatial streams and the first device D1 requests a packet extension length of either 4 μs or 8 μs, then the second device D2 may transmit a packet extension containing two of the 4 μs-long sounding LTFs 614 to the first device D1 using 2 spatial streams. In some aspects, the second device D2 may identify the 2×2 submatrix 613 within the packet extension matrix 612, and then select two LTF symbols with sign inversion for transmission to the first device D1 (such as by transmitting both rows of the submatrix 613 as packet extension 616 to the first device D1, for example, as described with respect to pattern P3 of FIG. 6A). If the second device D2 is to use 1 spatial stream and the first device D1 requests a packet extension length of either 4 μs or 8 μs, then the second device D2 may transmit a packet extension containing two of the 4 μs-long sounding LTFs 614 to the first device D1 via the first antenna ANT1, and also may transmit the packet extension containing same sounding LTFs 614 to the first device D1 via the second antenna ANT2 offset in time by a CSD value (such as 200 ns).

If the first device D1 requests a packet extension length of 16 μs, then the second device D2 may transmit a packet extension containing four of the 4 μs-long sounding LTFs 614 to the first device D1. In some aspects, the second device D2 may select four LTF symbols with sign inversion for transmission to the first device D1 (such as by transmitting the first 2 rows of packet extension matrix 612 as packet extension 616 to the first device D1, for example, as described with respect to pattern P7 of FIG. 6A).

For another example, if the second device D2 includes three antennas, then the second device D2 may transmit three spatial streams to the first device D1. In some implementations, the second device D2 may select, from four of the rows of the packet extension matrix 612, a number of sounding LTFs based on the packet extension length requested by the first device D1. In this case, the second device D2 may transmit a packet extension containing three of the 4 μs-long sounding LTFs 614 to the first device D1. In some aspects, the second device D2 may select four LTF symbols with sign inversion for transmission to the first device D1 (such as by transmitting the first 3 rows of packet extension matrix 612 as packet extension 616 to the first device D1, for example, as described with respect to pattern P8 of FIG. 6A).

For another example, if the second device D2 includes four antennas, then the second device D2 may transmit four spatial streams to the first device D1. In this case, the second device D2 may transmit a packet extension containing four of the 4 μs-long sounding LTFs 614 to the first device D1. In some aspects, the second device D2 may select four sounding LTFs (such as four LTF symbols) with sign inversion for transmission to the first device D1 (such as by transmitting all rows of packet extension matrix 612 as packet extension 616 to the first device D1, for example, as described with respect to pattern P9 of FIG. 6A). More specifically, the four different sounding LTFs 614 (denoted as sounding sequences LTF1, −LTF2, LTF3, and LTF4) may be transmitted as a first spatial stream SS1 to the first device D1 via the first antenna ANT1, a rotated version of the third sounding LTF 614 and non-rotated versions of the first, second and fourth sounding LTFs (denoted as sounding sequences LTF1, LTF2, −LTF3, and LTF4) may be transmitted as a second spatial stream SS2 to the first device D1 via the second antenna ANT2, non-rotated versions of the first, second, and third sounding LTFs 614 and a rotated version of the fourth sounding LTF 614 (denoted as sounding sequences LTF1, LTF2, LTF3, and −LTF4) may be transmitted as a third spatial stream SS3 to the first device D1 via the third antenna ANT3, and a rotated version of the first sounding LTF 614 and non-rotated versions of the second, third, and fourth sounding LTFs 614 (denoted as sounding sequences −LTF1, LTF2, LTF3, and LTF4) may be transmitted as a fourth spatial stream SS4 to the first device D1 via the fourth antenna ANT4.

FIGS. 6C(1) and 6C(2) show a table 620 including a number of example packet extension configurations. The example packet extension configurations shown in the table 620 may be based on the number of transmit antennas (Ntx), the number of spatial streams (Nsts) upon which the packet extension is to be transmitted, the packet extension length requested by the first device D1, the size or duration of the sounding LTFs, or any combination thereof. Although the example packet extension configurations shown in the table 620 include HE-LTFs, other sounding sequences (such as VHT-LTFs, HT-LTFs, or HE-NDPs) may be used, for example, as long as channel conditions or angle information may be estimated from the sounding sequences. Further, although the table 620 shows packet extension configurations for a transmitting device including up to eight antennas and using packet extensions up to 16 μs in duration, aspects of the present disclosure are not limited to the configurations shown in the example table 620, but rather may be used for packet extensions having a duration greater than 16 μs, for packet extensions transmitted from more than 8 antennas of a transmitting device, or for any combination thereof.

A transmitting device that includes one antenna may select one of seven different packet extension configurations depicted in the table 620 based on the number of spatial streams (Nsts) upon which the packet extension is to be transmitted, the requested packet extension length, and the size or duration of the sounding LTFs. If the packet extension length is 4 μs, then the transmitting device may use a 1× HE-LTF configuration and transmit the packet extension as a single spatial stream to another wireless device, for example, by generating one 1× HE-LTF symbol with no sign inversion and transmitting the 1× HE-LTF symbol.

If the packet extension length is 8 μs, then the transmitting device may either:
use a 1× HE-LTF configuration and transmit the packet extension as a single spatial stream by generating two 1× HE-LTF symbols with sign inversion defined by a 2×2 matrix and then transmitting only the first row of the 2×2 matrix (such as by transmitting row 1 of the submatrix 613 of FIG. 6B); or
use a 2× HE-LTF configuration and transmit the packet extension as a single spatial stream by generating one 2× HE-LTF symbol with no sign inversion and transmitting the 2× HE-LTF symbol.

If the packet extension length is 12 μs, then the transmitting device may use a 1× HE-LTF configuration and transmit the packet extension as a single spatial stream by generating two 1× HE-LTF symbols with sign inversion defined by a 2×2 matrix, copying the first HE-LTF symbol in the last 4 μs of the packet extension period, and transmitting only the first row of the 2×2 matrix.

If the packet extension length is 16 μs, then the transmitting device may either:
use a 1× HE-LTF configuration and transmit the packet extension as a single spatial stream by generating four 1× HE-LTF symbols with sign inversion defined by a 4×4 matrix and transmitting only the first row of the 4×4 matrix;
use a 2× HE-LTF configuration and transmit the packet extension as a single spatial stream by generating two 2× HE-LTF symbols with sign inversion defined by a 2×2 matrix, and transmitting only the first row of the 2×2 matrix; or
use a 4× HE-LTF configuration and transmit the packet extension as a single spatial stream by generating one 4× HE-LTF symbol with no sign inversion, and transmitting the 4× HE-LTF symbol.

A transmitting device that includes two antennas may select one of six different packet extension configurations depicted in the table 620 based on the number of spatial streams (Nsts) upon which the packet extension is to be transmitted, the requested packet extension length, and the size or duration of the sounding LTFs. If the packet extension length is 8 μs, then the transmitting device may either:
use a 1× HE-LTF configuration and transmit the packet extension as two spatial streams by generating two 1× HE-LTF symbols with sign inversion defined by a 2×2 matrix and then transmitting the two 1× HE-LTF symbols; or
use a 2× HE-LTF configuration and transmit the packet extension as a single spatial stream by generating one 2× HE-LTF symbol with no sign inversion, and transmitting the 2× HE-LTF symbol from a first antenna and transmitting the same 2× HE-LTF symbol from a second antenna offset in time relative to the transmission from the first antenna using a large per-chain CSD value (such as 200 ns).

If the packet extension length is 12 μs, then the transmitting device may use a 1× HE-LTF configuration and transmit the packet extension as two spatial streams by generating two 1× HE-LTF symbols with sign inversion defined by a 2×2 matrix, copying the first HE-LTF symbol in the last 4 μs of the packet extension period, and then transmitting the resulting HE-LTF symbols.

If the packet extension length is 16 μs, then the transmitting device may either:
use a 1× HE-LTF configuration and transmit the packet extension as two spatial streams by generating four 1× HE-LTF symbols with sign inversion defined by a 4×4 matrix and then transmitting the first and second rows of the 4×4 matrix;
use a 2× HE-LTF configuration and transmit the packet extension as two spatial streams by generating two 2× HE-LTF symbols with sign inversion defined by a 2×2 matrix and transmitting the resultant two HE-LTFs as two spatial streams; or
use a 4× HE-LTF configuration and transmit the packet extension as a single spatial stream by generating one 4× HE-LTF symbol with no sign inversion, and transmitting the 4× HE-LTF symbol from a first antenna and transmitting the same 4× HE-LTF symbol from a second antenna offset in time relative to the transmission from the first antenna using a large per-chain CSD value (such as 200 ns).

A transmitting device that includes three antennas may select one of three different packet extension configurations depicted in the table 620 based on the number of spatial streams (Nsts) upon which the packet extension is to be transmitted, the requested packet extension length, and the size or duration of the sounding LTFs.

A transmitting device that includes four antennas may select one of three different packet extension configurations depicted in the table 620 based on the number of spatial streams (Nsts) upon which the packet extension is to be transmitted, the requested packet extension length, and the size or duration of the sounding LTFs.

A transmitting device that includes five antennas may select one of three different packet extension configurations depicted in the table 620 based on the number of spatial streams (Nsts) upon which the packet extension is to be transmitted, the requested packet extension length, and the size or duration of the sounding LTFs.

A transmitting device that includes six antennas may select one of three different packet extension configurations depicted in the table 620 based on the number of spatial streams (Nsts) upon which the packet extension is to be transmitted, the requested packet extension length, and the size or duration of the sounding LTFs.

A transmitting device that includes seven antennas may select one of three different packet extension configurations depicted in the table 620 based on the number of spatial streams (Nsts) upon which the packet extension is to be transmitted, the requested packet extension length, and the size or duration of the sounding LTFs.

A transmitting device that includes eight antennas may select one of three different packet extension configurations depicted in the table 620 based on the number of spatial streams (Nsts) upon which the packet extension is to be transmitted, the requested packet extension length, and the size or duration of the sounding LTFs.

In some implementations, if the second device D2 includes 4 or less antennas, then the number of spatial streams used to transmit packet extensions containing sounding LTFs may be equal to the number of transmit antennas (such as if Ntx≦4, then Nsts=Ntx). For example, referring also to FIGS. 5A-5B, if the second device D2 includes four antennas ANT1-ANT4 (such as depicted in the illustration 610 of FIG. 6B), then the second device D2 may use all four antennas for the example ranging operation 500A. In some implementations, the second device D2 may avoid antenna switching operations by using all four antennas to transmit both the body of the FTM frame and its associated HE packet extension. The second device D2 may eliminate CSD between its transceiver chains so that the first device D1 may readily detect the first arrival path (FAP), which may be important to obtain accurate RTT measurements. In some aspects, the second device D2 may transmit the body of the FTM frame as a single spatial stream using four antennas with no per-chain CSD, and may transmit the HE packet extension as four spatial streams using four antennas with no per-chain CSD. Because the HE packet extension is transmitted as four spatial streams, there may be a per-stream CSD associated with transmission of the packet extension. In some implementations, the second device D2 may set the CSD between spatial streams used to transmit the HE packet extension to a value specified by the IEEE 802.11ax standards, for example, because wireless devices operating in accordance with the IEEE 802.11ax standards may be configured to remove the specified per-stream CSD.

In implementations for which the second device D2 includes 8 antennas, the second device D2 may use a first set of four antennas ANT1-ANT4 to transmit the four spatial streams SS1-SS4 (as described with respect to FIG. 6B), and may use a second set of four antennas ANT5-ANT8 to transmit the same four spatial streams SS1-SS4, albeit with a relatively large cyclic shift diversity (CSD) value introduced between the transceiver chains associated with the first set of four antennas ANT1-ANT4 and the transceiver chains associated with the second set of four antennas ANT5-ANT8. As used herein, the “relatively large CSD” may refer to a CSD value sufficient to allow the first device D1 to distinguish the FAP of the FTM frame from multipath reflections.

In some implementations, a negative CSD value may be used, for example, so that the spatial streams transmitted by the second set of four antennas ANT5-ANT8 are delayed with respect to the spatial streams transmitted by the first set of four antennas ANT1-ANT4 by an amount sufficient for the first device D1 to determine that the spatial streams transmitted by the first set of four antennas ANT1-ANT4 correspond to the FAP of the FTM frame. In some other implementations, a positive CSD value may be used, for example, so that the spatial streams transmitted by the first set of four antennas ANT1-ANT4 are delayed with respect to the spatial streams transmitted by the second set of four antennas ANT5-ANT8. For these implementations, the first device D1 may use the spatial streams SS1-SS4 transmitted by the first set of antennas ANT1-ANT4 as the FAP to estimate MIMO channel conditions (and may ignore the spatial streams SS1-SS4 transmitted by the second set of antennas ANT5-ANT8).

In some aspects, the group of spatial streams transmitted by the first set of antennas ANT1-ANT4 may be separated in time from the group of spatial streams transmitted from the second set of antennas ANT5-ANT8, for example, so that the first device D1 may use both groups of spatial streams to derive two different MIMO channel estimates from a single exchange of HE packets which encapsulate FTM frames. Because the channel delay spread is usually less than 400 ns, a CSD value of 400 μs between the two groups of spatial streams may provide sufficient separation in time.

In some implementations, the first device D1 may use the table 600 of FIG. 6A to determine whether received HE packet extensions contain sounding LTFs from which angle information may be estimated, or whether received HE packet extensions contain a random pattern of dummy data that allows a receiving device sufficient time to receive the entire HE packet without giving up medium access. In some aspects, if the first device D1 determines that a received HE packet extension contains sounding LTFs from which angle information may be estimated, then the first device D1 may process the sounding LTFs to estimate channel conditions between itself and the transmitting device, and thereafter derive angle information from the estimated channel conditions. In the alternative, the first device D1 may estimate angle information based on the sounding LTFs, for example, by determining phase differences between signal components of the packet extension transmitted from multiple antennas of the second device D2 (such as to estimate AoD information) or by determining phase differences between signal components of the packet extension received at multiple antennas of the first device D1 (such as to estimate AoA information). Conversely, if the first device D1 determines that the received HE packet extension does not contain sounding LTFs, then the first device D1 may ignore the contents of the HE packet extension (such as and not attempt to estimate channel conditions based on the contents of the HE packet extension).

FIG. 7A shows a flow chart depicting an example ranging operation 700. The example ranging operation 700 may be performed between a first device D1 and a second device D2. The first device D1 and the second device D2 each may be, for example, an access point (such as the AP 110 of FIG. 1), a station (such as one of the stations STA1-STA4 of FIG. 1), or another suitable wireless device (such as the wireless device 200 of FIG. 2).

The first device D1 transmits, to the second device D2, an FTM_REQ frame requesting the ranging operation (702). The first device D1 receives, from the second device D2, an FTM frame including a packet extension (704). The first device D1 determines whether the packet extension contains sounding LTFs (706). The first device D1 may selectively perform the ranging operation based on whether the packet extension contains sounding LTFs (708).

If the first device D1 determines that the packet extension does not contain sounding LTFs, as tested at 710, then the ranging operation ends. Conversely, if the first device D1 determines that the packet extension contains sounding LTFs, as tested at 710, then the first device D1 may estimate channel conditions based on the sounding LTFs (712). The first device D1 may derive angle information of the FTM frame based on the estimated channel conditions (714). The estimated angle information may include estimated AoD information, estimated AoA information, or both. The first device D1 may optionally determine the number of sounding LTFs contained in the packet extension and how many antennas transmitted the packet extension based, at least in part, on a length of the packet extension (716).

In some aspects, the length of the packet extension may determine how many sounding LTFs may be contained therein. Thus, if the first device D1 determines the length of the received packet extension, the first device D1 may consult the Table 600 of FIG. 6A to determine how many sounding LTFs are contained in the packet extension, and may be able to determine how many antennas were used to transmit the packet extension. For example, if the first device D1 determines that the packet extension is 4 μs long, the first device D1 may determine that the packet extension contains pattern P1 and was transmitted using a single antenna. For another example, if the first device D1 determines that the packet extension is 8 μs long, the first device D1 may determine that the packet extension contains at least pattern P2, and also may contain pattern P3.

The first device D1 may determine whether the packet extension of the HE packet which encapsulates the FTM frame contains sounding LTFs in any suitable manner. In some implementations, the first device D1 may extract a number of patterns from the packet extension, compare the extracted patterns with a number of reference sequences, and determine whether the extracted patterns are sounding LTFs based on the comparison. In some aspects, the first device D1 may store the patterns P1-P13 of the Table 600 as the reference sequences in a suitable memory (such as in the packet extension LUT 242 of FIG. 2), and then determine one or more degrees of correlation between the extracted patterns and the reference sequences. The one or more degrees of correlation may be combined (such as summed) and compared with one or more threshold values. The results of the comparison operation may be used to determine whether the received packet extension contains sounding LTFs from which channel conditions or angle information may be estimated. The results of the comparison operation also may be used to identify the specific sounding LTFs contained in the received packet extension.

In some implementations, the first device D1 may generate a correlation result (CR) between an extracted pattern and a reference sequence by performing a point-to-point multiplication between corresponding bits of the extracted pattern and the reference sequence and then summing the resulting product values. For example, if corresponding bits or “samples” of the extracted pattern and the reference sequence are the same (such as bit 0 of the extracted pattern is a logic one and bit 0 of the reference sequence is a logic one), then the resulting product value is positive. Conversely, if corresponding bits or samples of the extracted pattern and the reference sequence are not the same (such as bit 0 of the extracted pattern is a logic zero and bit 0 of the reference sequence is a logic one), then the resulting product value is negative (or zero). Thus, a greater number of bit matches between the extracted pattern and the reference sequence may result in a greater positive CR value, while a fewer number of bit matches between the extracted pattern and the reference sequence may result in a lesser positive CR value.

The CR value may be compared with a threshold (TH) value to determine whether the extracted pattern matches the reference sequence. For example, if the value of CR is greater than the value of TH, then the first device D1 may determine a match between the extracted pattern and the reference sequence. Conversely, if the value of CR is less than (or equal to) the value of TH, the first device D1 may determine a mismatch between the extracted pattern and the reference sequence.

In some implementations, the value of CR may be based on a relatively high threshold value (TH_{high}) and a relatively low threshold value (TH_{low}). Comparing the value of CR with the relatively low threshold value TH_{low} may ensure that coincidental matches between corresponding bits or samples of the extracted pattern and the reference sequence do not indicate a false match. For example, if the second device D2 transmits a packet extension containing a random sequence used as padding, some of the bits of the random sequence may match corresponding bits of the reference sequence, and therefore the resulting CR value may have a positive value (even though the random sequence is not a sounding LTF from which angle information may be estimated or derived). Thus, the value of TH_{low} may be set to a positive value that prevents false matches between random sequences contained in the packet extension and the reference sequences. In some aspects, the value of TH_{low} may be based on a statistical analysis indicating the probability of how many bits of a random sequence are likely to match corresponding bits of the reference sequences.

Comparing the value of CR with the relatively high threshold value TH_{high} may ensure that noise or multipath effects do not result in a false mismatch between the extracted pattern and the reference sequence. For example, if the second device D2 transmits a packet extension containing the sounding sequence LTF1 of the Table 600, one or more bits of the transmitted pattern LTF1 may be received in error by the first device D1. Thus, even though the extracted pattern should be the same as the reference sequence corresponding to the sounding sequence LTF1, some of the bitwise operations between the extracted pattern and the reference sequence may not yield a positive point-to-point multiplication product. Thus, the value of TH_{high} may be set to a positive value that accounts for bitwise mismatches resulting from noise and multipath effects.

In some aspects, the value of TH may be selected as the midpoint between the values of TH_{high} and TH_{low}. For example, the value of THhi_{g}h for a given reference sequence may be selected as the correlation result between the reference sequence and itself, and the value of TH_{low} may be selected as the correlation result between the reference sequence and noise.

The number of correlations performed by the first device D1 to determine whether a received packet extension contains sounding LTFs may be based on the length of the received packet extension. For example, if the received packet extension has a length of 4 μs, then the first device D1 may correlate the extracted pattern with pattern P1 of the Table 600 to generate a correlation result CR, and compare the value of CR with a threshold (TH) to determine whether the received packet extension contains the sounding sequence LTF1 corresponding to pattern P1. In some aspects, the first device D1 may determine whether the received packet extension contains sounding LTFs as follows:
if CR≦TH, then the first device D1 may determine that the received packet extension does not contain any sounding LTFs; and
if CR>TH, then the first device D1 may determine that the received packet extension contains the sounding sequence LTF1 and that the packet extension was transmitted using a single antenna.

For another example, if the received packet extension has a length of 8 μs, then the first device D1 may correlate the extracted pattern with patterns P2 and P3 of the Table 600 to generate correlation results CR2 and CR3, respectively. The first device D1 may compare the value of CR2 with a second threshold (TH2), and may compare the value of CR3 with a third threshold (TH3). In some aspects, the first device D1 may determine whether the received packet extension contains sounding LTFs as follows:
if CR2≦TH2, then the first device D1 may determine that the received packet extension does not contain any sounding LTFs;
if CR2>TH2 and CR3≦TH3, then the first device D1 may determine that the received packet extension contains 2 sounding LTFs and was transmitted using a single antenna; and
if CR2>TH2 and CR3>TH3, then the first device D1 may determine that the received packet extension contains 2 sounding LTFs and was transmitted using 2 antennas.

For another example, if the received packet extension has a length of 12 μs, then the first device D1 may correlate the extracted pattern with patterns P4 and P5 of Table 600 to generate correlation results CR4 and CR5, respectively. The first device D1 may compare the value of CR4 with a fourth threshold (TH4), and may compare the value of CR5 with a fifth threshold (TH5). In some aspects, the first device D1 may determine whether the received packet extension contains sounding LTFs as follows:
if CR4≦TH4, then the first device D1 may determine that the received packet extension does not contain any sounding LTFs;
if CR4>TH4 and CR5≦TH5, then the first device D1 may determine that the received packet extension contains 3 sounding LTFs and was transmitted using a single antenna; and
if CR4>TH4 and CR5>TH5, then the first device D1 may determine that the received packet extension contains 3 sounding LTFs and was transmitted using 2 antennas.

For another example, if the received packet extension has a length of 16 μs, then the first device D1 may correlate the extracted pattern with patterns P6 through P13 of the Table 600 to generate correlation results CR6-CR13, respectively. The first device D1 may compare the value of each of the correlation results CR6-CR13 with a corresponding one of thresholds TH6-TH13. In some aspects, the first device D1 may determine whether the received packet extension contains sounding LTFs as follows:
if CR6≦TH6, then the first device D1 may determine that the received packet extension does not contain any sounding LTFs;
if CR6>TH6 and CR7≦TH7, then the first device D1 may determine that the received packet extension contains 4 sounding LTFs and was transmitted using a single antenna;
if CR6>TH6 and CR7>TH7 and CR8≦TH8, then the first device D1 may determine that the received packet extension contains 4 sounding LTFs and was transmitted using 2 antennas;
if CR6>TH6 and CR7>TH7 and CR8>TH8 and CR9≦TH9, then the first device D1 may determine that the received packet extension contains 4 sounding LTFs and was transmitted using 3 antennas;
if CR6>TH6 and CR7>TH7 and CR8>TH8 and CR9>TH9 and CR10≦TH10, then the first device D1 may determine that the received packet extension contains 4 sounding LTFs and was transmitted using 4 antennas;
if CR6>TH6 and CR7>TH7 and CR8>TH8 and CR9>TH9 and CR10>TH10 and CR11≦TH11, then the first device D1 may determine that the received packet extension contains 4 sounding LTFs and was transmitted using 5 antennas;
if CR6>TH6 and CR7>TH7 and CR8>TH8 and CR9>TH9 and CR10>TH10 and CR11>TH11 and CR12≦TH12, then the first device D1 may determine that the received packet extension contains 4 sounding LTFs and was transmitted using 6 antennas;
if CR6>TH6 and CR7>TH7 and CR8>TH8 and CR9>TH9 and CR10>TH10 and CR11>TH11 and CR12>TH12 and CR13≦TH13, then the first device D1 may determine that the received packet extension contains 4 sounding LTFs and was transmitted using 7 antennas;
if CR6>TH6 and CR7>TH7 and CR8>TH8 and CR9>TH9 and CR10>TH10 and CR11>TH11 and CR12>TH12 and CR13>TH13, then the first device D1 may determine that the received packet extension contains 4 sounding LTFs and was transmitted using 8 antennas.

FIG. 7B shows a flow chart depicting an example operation 720 for determining whether an HE packet extension contains sounding LTFs. The first device D1 may receive the packet extension and extract patterns contained therein (722). The first device D1 may determine a length or transmit duration of the received packet extension (724), and may select a number of reference sequences and a number of threshold values based on the determined length (726). For example, if the packet extension has a length of 4 μs, then the first device D1 may select pattern P1 of the Table 600 as the reference sequence and select TH as the threshold value. For example, if the packet extension has a length of 8 μs, then the first device D1 may select patterns P2 and P3 of the Table 600 as the reference sequences and select TH1 and TH2 as the threshold values.

The first device D1 may determine whether the extracted pattern includes a number of sounding LTFs by correlating the extracted pattern with the selected reference sequences using the selected threshold value(s) (728). In some aspects, the first device D1 may generate a correlation result for each of the selected reference sequences (728A), and may compare each correlation result with a corresponding one of the selected threshold values (728B).

FIG. 7C shows a flow chart depicting another example ranging operation 730. The example ranging operation 730 may be performed between a first device D1 and a second device D2. The first device D1 and the second device D2 each may be, for example, an access point (such as the AP 110 of FIG. 1), a station (such as one of the stations STA1-STA4 of FIG. 1), or another suitable wireless device (such as the wireless device 200 of FIG. 2).

The first device D1 may transmit, to the second device D2, a frame requesting a length of packet extensions to be used for the ranging operation (731). In some implementations, the frame may be an FTM_REQ frame which also may request the ranging operation. In some aspects, the FTM_REQ frame may include a vendor-specific information element (VSIE) containing the request to initiate the ranging operation and the requested packet extension length. In addition, or in the alternative, the FTM_REQ frame also may include a request for the second device D2 to capture timestamps (such as TOA information of frames received by the second device D2 and TOD information of frames transmitted from the second device D2), may include a request for the second device D2 to estimate angle information (such as AoA and AoD information of packets received by the second device D2), or both.

The first device D1 may receive, from the second device D2, a high efficiency (HE) packet including a packet extension that contains a selected number of LTFs (732). The HE packet may encapsulate an FTM frame (such as the FTM_1 frame of FIG. 5A). In some implementations, the selected number of LTFs may be based at least in part on the requested packet extension length. In some aspects, the selected number of LTFs also may be based on the number of antennas used by the second device D2 to transmit the packet extension, on the number of spatial streams used by the second device D2 to transmit the packet extension, on the size or duration of the sounding LTFs, or any combination thereof.

The first device D1 may determine that the packet extension contains sounding LTFs (733). In some implementations, the first device D1 may detect, in a preamble of the HE packet, a bit indicating that the packet extension contains sounding LTFs. In some aspects, if the bit is asserted to indicate that the packet extension contains sounding LTFs, the first device D1 may prepare to process sounding LTFs received from the second device D2, for example, to estimate angle information of the HE packet. Conversely, if the bit is not asserted to indicate that the packet extension does not contain sounding LTFs, the first device D1 may not prepare for estimating angle information based on received sounding LTFs, for example, to reduce power consumption. Providing a bit in the HE packet to indicate the presence (or absence) of sounding LTFs in the packet extension may allow the first device D1 to determine whether the packet extension contains sounding LTFs on a per-packet basis.

In some other implementations, the first device D1 may determine that the packet extension contains sounding LTFs by extracting a pattern from the packet extension and correlating the extracted pattern with a number of reference sequences. In some aspects, the first device D1 may determine a degree of correlation between the extracted pattern and the reference sequences, may compare the determined degree of correlation with one or more threshold values, and may determine whether the extracted pattern includes sounding LTFs based on the comparison. In this manner, the first device D1 may determine the presence (or absence) of sounding LTFs in HE packet extensions on a per-packet basis without using a dedicated bit in the preamble of HE packets (or other special signaling techniques).

The first device D1 may perform the ranging operation with the second device D2 based on a determination that the packet extension contains sounding LTFs (734). For example, if the packet extension transmitted by the second device D2 contains sounding LTFs, the first device D1 may perform or participate in the ranging operation with the second device D2. Conversely, if the packet extension transmitted by the second device D2 does not contain sounding LTFs, the first device D1 may not perform or participate in the ranging operation with the second device D2.

The first device D1 may estimate angle of departure (AoD) information or angle of arrival (AoA) information of the HE packet based on the selected number of LTFs contained in the packet extension (735). In some implementations, the first device D1 may estimate channel conditions based on the received LTFs, and derive angle information of the HE packet based on the estimated channel conditions. In some other implementations, the first device D1 may use phase differences between signal components of the HE packet extension to estimate angle information of the HE packet.

The first device D1 may transmit, to the second device D2, a feedback frame including the estimated AoD information or AoA information (736). The feedback frame may be any suitable frame that can contain the estimated angle information. The second device D2 may receive the feedback frame, and may use the estimated angle information to determine its position relative to the first device D1.

FIG. 7D shows a flow chart depicting another example ranging operation 740. The example ranging operation 740 may be performed between a first device D1 and a second device D2. The first device D1 and the second device D2 each may be, for example, an access point (such as the AP 110 of FIG. 1), a station (such as one of the stations STA1-STA4 of FIG. 1), or another suitable wireless device (such as the wireless device 200 of FIG. 2).

The second device D2 may receive, from the first device D1, a frame requesting a length of packet extensions to be used for the ranging operation (741). In some implementations, the frame may be an FTM_REQ frame which also may request the ranging operation. In some aspects, the FTM_REQ frame may include a VSIE containing the request to initiate the ranging operation and the requested packet extension length. In addition, or in the alternative, the FTM_REQ frame also may include a request for the second device D2 to capture timestamps (such as TOA information of frames received by the second device D2 and TOD information of frames transmitted from the second device D2), may include a request for the second device D2 to estimate angle information (such as AoA and AoD information of packets received by the second device D2), or both.

The second device D2 may select a number of sounding LTFs based, at least in part, on the requested packet extension length (742). In some implementations, the selected number of sounding LTFs also may be based on the number of antennas used by the second device D2 to transmit the packet extension, on the number of spatial streams used by the second device D2 to transmit the packet extension, on the size or duration of the sounding LTFs (such as 1× HE-LTF, 2× HE-LTF, or 4× HE-LTF) used by the second device D2 to transmit the packet extension, or any combination thereof.

The second device D2 may transmit, to the first device D1, an HE packet including a packet extension containing the selected number of sounding LTFs (743). In some implementations, the second device D2 may provide, in a preamble of the HE packet, a bit indicating that the packet extension of the HE packet contains sounding LTFs. The first device D1 may determine whether the packet extension of the HE packet contains sounding LTFs based on a state (such as a logic level) of the indication bit.

The second device D2 may receive, from the first device D1, a feedback frame including estimated angle of departure (AoD) information or angle of arrival (AoA) information of the HE packet (744). In some implementations, the first device D1 may estimate channel conditions based on the received sounding LTFs, and may derive angle information of the HE packet based on the estimated channel conditions. In some other implementations, the first device D1 may use phase differences between signal components of the HE packet extension to estimate angle information of the HE packet). The feedback frame may be any suitable frame that can contain the estimated angle information. The second device D2 may use the estimated angle information provided by the first device D1 to determine its position relative to the first device D1.

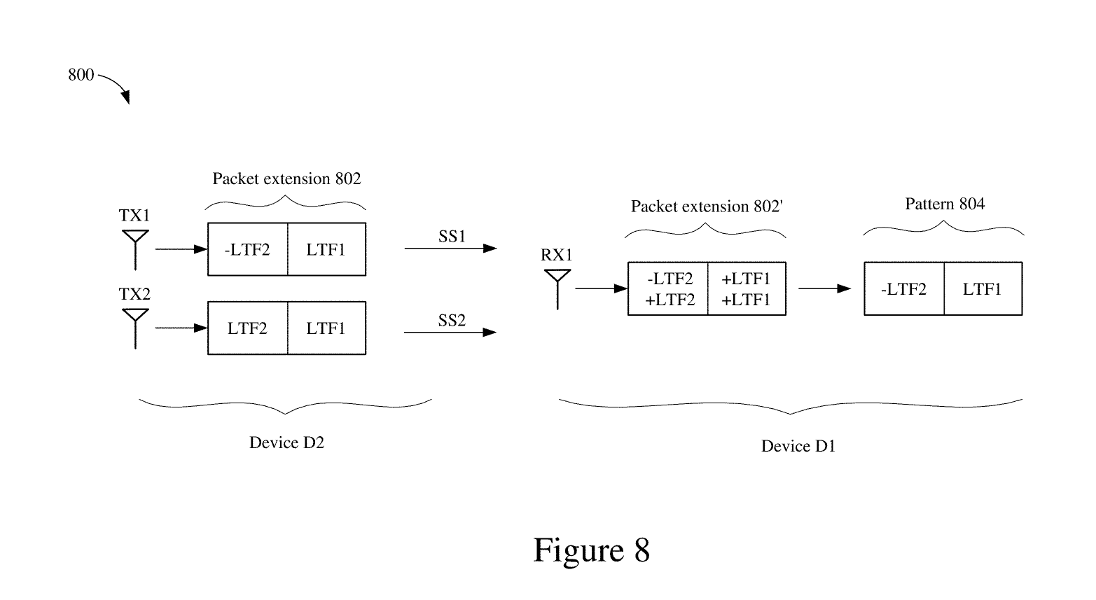

FIG. 8 shows an illustration 800 depicting a wireless device processing a received HE packet extension. For the example illustration 800, the first device D1 is depicted as processing an HE packet extension 802 transmitted from the second device D2, for example, to determine whether the HE packet extension 802 contains sounding LTFs. In some aspects, the first device D1 may be a STA and the second device D2 may be an AP. In some other aspects, the first device D1 may be an AP and the second device D2 may be a STA. In some other aspects, each of the first device D1 and the second device D2 may be an AP, or each of the first device D1 and the second device D2 may be a STA.

The second device D2 is shown to include two antennas TX1 and TX2, and the first device D1 is shown to include a single antenna RX1. Referring also to the Table 600 of FIG. 6A, the second device D2 transmits the HE packet extension 802 containing patterns P2 and P3 as 2 spatial streams (SS1 and SS2) to the first device D1. In some aspects, the second device D2 transmits sounding sequences LTF1 and −LTF2 as a first spatial stream SS1 from a first antenna TX1, and transmits sounding sequences LTF1 and LTF2 as a second spatial stream SS2 from a second antenna TX2, for example, as shown in the example illustration 800. The first device D1 receives both spatial streams SS1 and SS2 via a single antenna RX1, and the spatial streams SS1 and SS2 may combine (such as sum) at the antenna RX1 of the first device D1.

For example, the sounding sequence LTF1 in spatial stream SS1 and the sounding sequence LTF1 in spatial stream SS2 may be summed as +1 and +1, and the sounding sequence −LTF2 in spatial stream SS1 and the sounding sequence LTF2 in spatial stream SS2 may be summed as −1 and +1 (as denoted by the received packet extension 802′ in FIG. 8). The results of this summing may be a pattern 804 that includes sounding sequence LTF1 and sounding sequence −LTF2, as depicted in FIG. 8. For example, the first device D1 may correlate the pattern 804 (containing LTF1 and −LTF2) with patterns P2 and P3 of the Table 600 in FIG. 6A.

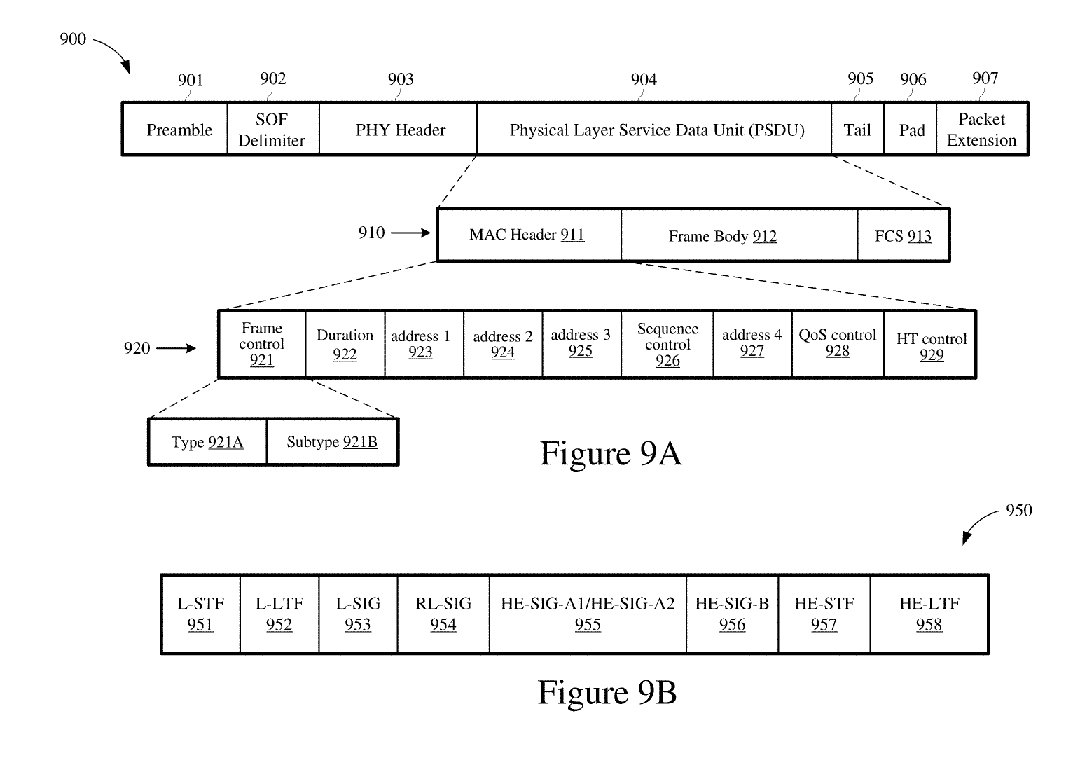

FIG. 9A shows an example packet 900. The packet 900 may be used as one or more of the HE packets for the example ranging operations disclosed herein. In some implementations, the packet 900 may encapsulate the FTM_REQ frame, the FTM_1 frame, and the FTM_2 frame of the ranging operation 500A of FIGS. 5A-5C. In addition, or in the alternative, the packet 900 may encapsulate the ACK1 and ACK2 frames of the ranging operation 500A of FIGS. 5A-5C. The packet 900 is shown to include a preamble 901, a start of frame (SOF) delimiter 902, a physical-layer (PHY) header 903, a Physical Layer Service Data Unit (PSDU) 904, a tail field 905, a pad field 906, and a packet extension 907, for example, as defined in the IEEE 802.11 standards.

The preamble 901 may include synchronization information, timing information, frequency offset correction information, and signaling information, for example, as described in more detail with respect to FIG. 9B. The SOF delimiter 902 may indicate the start of the data frame encapsulated within the packet 900. The PHY header 903 may include a number of fields for storing data rates, a reserved bit, a length of the PSDU 904, a parity bit, a number of tail bits, and service information. The PSDU 904 may contain an MPDU 910. The tail field 905 may include a number of tail bits, and the pad field 906 may include a number of pad bits.

The MPDU 910, which may be commonly referred to as a MAC frame, may be compliant with the IEEE 802.11 family of standards. The MPDU 910 includes a MAC header 911, a frame body 912, and a frame check sequence (FCS) field 913. The MAC header 911 may include a number of fields containing information that describes characteristics or attributes of data encapsulated within the frame body 912, may include a number of fields indicating source and destination addresses of the data encapsulated within the frame body 912, and may include a number of fields containing control information. In some implementations, MAC header 911 may be used as the MAC header of any suitable data frame, control frame, management frame, or action frame (such as the FTM frames and the ACK frames used in the example ranging operations of FIGS. 5A-5C).

FIG. 9A also shows a MAC header 920 that may be an implementation of the MAC header 911 of the MPDU 910. The MAC header 920 may include a frame control field 921, a duration field 922, an address 1 field 923, an address 2 field 924, an address 3 field 925, a sequence control field 926, an address 4 field 927, a Quality of Service (QoS) control field 928, and a high-throughput (HT) control field 929. The frame control field 921 includes a Type field 921A and a Sub-type field 921B. The Type field 921A may store a value indicating whether the MAC frame 920 is a control frame, a data frame, or a management frame, and the Sub-type field 921B may store a value indicating a type of control frame, data frame, or management frame.

The duration field 922 may store the value of the Network Allocation Vector (NAV). The address 1 field 923 may store the MAC address of the receiving device, the address 2 field 924 may store the MAC address of the transmitting device, and the address 3 field 925 may be used for filtering (such as by an AP). The sequence control field 926 may store sequence information (such as used for data re-transmissions). The address 4 field 927 may store mesh address information. The QoS control field 928 may store optional QoS control information (such as a traffic class), and the HT control field 929 may store information for high-throughput packets. In some implementations, the frame control field 921 is 2 bytes, the duration field 922 is 2 bytes, the address 1 field 932 is 6 bytes, the address 2 field 924 is 6 bytes, the address 3 field 925 is 6 bytes, the sequence control field 926 is 2 bytes, the address 4 field 927 is 0 or 6 bytes, the QoS control field 928 is 0 or 2 bytes, and the HT field 929 is 0 or 4 bytes. In some other implementations, the fields of the MAC header 920 of FIG. 9A may be of other suitable lengths.

The packet extension 907 does not typically store any data. Instead, the packet extension 907 typically stores “dummy” data (such as repeating the last symbol of the packet payload), for example, to allow a receiving device more time to decode packet 900 without giving up medium access granted to a transmitting device. In accordance with the subject matter described in this disclosure, the packet extension 907 may be used to store one or more sounding sequences such as, for example, sounding LTFs. The sounding LTFs may be HE-LTFs, VHT-LTFs, HT-LTFs, or any LTFs from which channel conditions or angle information may be estimated. In some aspects, the sounding LTFs contained in the packet extension 907 may be used to by a receiving device to estimate MIMO channel conditions, which in turn may be used by the receiving device to estimate angle information of frames packets transmitted by a transmitted device. In some other aspects, the sounding LTFs contained in the packet extension 907 may be used to estimate angle information, for example, based on phase differences between signal components of the packet extension 907 transmitted from multiple antennas of the transmitting device or on phase differences between signal components of the packet extension 907 received at multiple antennas of the receiving device.

The packet extension 907 may have different lengths or durations, for example, as depicted in the table 620 shown in FIGS. 6C(1) and 6C(2). In some implementations, the packet extension 907 may have a maximum transmit duration of 16 μs, and each of the sounding LTFs may have a maximum transmit duration of 4 μs. As such, the packet extension 907 may be able to contain four of the sounding LTFs. In some other implementations, the maximum transmit duration of each of the sounding LTFs may be adjusted based on the configuration of the sounding LTFs. In some aspects, the maximum transmit duration of each of the sounding LTFs may be 4 μs, for example, when using a 1× HE-LTF configuration (such as because four 4 μs-long HE-LTFs may fit within a 16 μs-long packet extension). A transmitting device including 8 antennas may transmit the four 4 μs-long HE-LTFs from a first set of 4 antennas and also may transmit the four 4 μs-long HE-LTFs from a second set of 4 antennas, offset in time by a CSD value (such as 200 ns).

In some other aspects, the maximum transmit duration of each of the sounding LTFs may be 8 μs, for example, when using a 2× HE-LTF configuration (such as because two 8 μs-long HE-LTFs may fit within a 16 μs-long packet extension). A transmitting device including 8 antennas may transmit the two 8 μs-long LTFs from a first set of 2 antennas, may transmit the two 8 μs-long LTFs from a second set of 2 antennas offset in time by a first CSD value (such as 200 ns), may transmit the two 8 μs-long LTFs from a third set of 2 antennas offset in time by a second CSD value (such as 400 ns), and may transmit the two 8 μs-long LTFs from a fourth set of 2 antennas offset in time by a third CSD value (such as 600 ns), for example, as depicted in the table 620 of FIGS. 6C(1) and 6C(2).

In some other aspects, the maximum transmit duration of the sounding LTFs may be 16 μs, for example, when using a 4× HE-LTF configuration (such as because one 16 μs-long HE-LTF may fit within a 16 μs-long packet extension). A transmitting device including 8 antennas may transmit the one 16 μs-long LTF from each of its 8 antennas offset in time by a CSD value applied between each of the antennas. For example, the transmitting device may transmit the one 16 μs-long LTF from a first antenna, may transmit the one 16 μs-long LTF from a second antenna offset in time by a first CSD value, may transmit the one 16 μs-long LTF from a third antenna offset in time by a second CSD value, may transmit the one 16 μs-long LTF from a fourth antenna offset in time by a third CSD value, may transmit the one 16 μs-long LTF from a fifth antenna offset in time by a fourth CSD value, may transmit the one 16 μs-long LTF from a sixth antenna offset in time by a fifth CSD value, may transmit the one 16 μs-long LTF from a seventh antenna offset in time by a sixth CSD value, and may transmit the one 16 μs-long LTF from an eighth antenna offset in time by a seventh CSD value, for example, as depicted in the table 620 of FIGS. 6C(1) and 6C(2).

In some implementations, an antenna mask may be added to the FTM frames of FIG. 5A, for example, by using a number of reserved bits in the TOD error field, a number of reserved bits in the TOA error field, or a number of reserved bits in the TOD and TOA error fields. The number of bits in the antenna mask may correspond to the number of antennas of the transmitting device. For example, if the transmitting device includes 8 antennas, then the antenna mask may include 8 bits, each indicating whether a corresponding one of the 8 antennas is used to transmit the FTM frame and the packet extension. In some aspects, a bit value of “1” may indicate that the corresponding antenna is used to transmit the FTM frame and the packet extension, and a bit value of “0” may indicate that the corresponding antenna is not used to transmit the FTM frame and the packet extension.

For example, if the transmitting device uses a first set of four antennas to transmit the FTM frame and packet extension, then the antenna mask transmitted with the FTM frame may be “00001111” to indicate that the first set of four antennas is used and the second set of four antennas is not used. In another example, if the transmitting device uses the second set of four antennas to transmit the FTM frame and the packet extension, then the antenna mask transmitted with the FTM frame may be “11110000” to indicate that the second set of four antennas is used and the first set of four antennas is not used.

FIG. 9B shows an example high-efficiency (HE) preamble 950. The HE preamble 950 may be one implementation of the preamble 901 of the packet 900 of FIG. 9A. The preamble 950, which in some aspects may be compliant with the IEEE 802.11ax standards, is shown to include a Legacy Short Training Field (L-STF) 951, a Legacy Long Training Field (L-LTF) 952, a Legacy Signal (L-SIG) field 953, a Repeated Legacy Signal (RL-SIG) field 954, a set of HE Signal-A (HE-SIG-A1/HE-SIG-A2) fields 955, an HE Signal B (HE-SIG-B) field 956, an HE Short Training Field (HE-STF) 957, and an HE Long Training Field (HE-LTF) 958.

The L-STF 951 may include information for coarse frequency estimation, automatic gain control, and timing recovery. The L-LTF 952 may include information for fine frequency estimation, channel estimation, and fine timing recovery. In some aspects, the L-LTF 952 may include information from which an RTT measurement may be determined, for example, as described with respect to FIGS. 5A-5C.

The L-SIG field 953 may include modulation and coding information.

The RL-SIG field 954, which may be used to identify the packet 900 as an HE packet, may include a time-domain waveform generated by repeating the time-domain waveform of the L-SIG field 953. The HE-SIG-A1 and HE-SIG-A2 fields 955 may include parameters such as an indicated bandwidth, a payload guard interval (GI), a coding type, a number of spatial streams (Nsts), a space-time block coding (STBC), beamforming information, and so on.

The HE-SIG-A1 and HE-SIG-A2 fields 955 may include a set of fields to store parameters describing the type of information stored in the HE-LTF 958 (such as whether the HE-LTF 958 is configured with information from which a receiving device may obtain an RTT measurement). For example, the set of fields includes (1) a CP+LTF Size field that stores a cyclic prefix (CP) value and a length of the HE-LTF 958; (2) an Nsts field to store information indicating the number spatial streams, (3) a STBC field store a value for space-time block coding, and (4) a transmit beamforming (TxBF) field to store information pertaining to beamforming. In some implementations, the HE-SIG-A1 and HE-SIG-A2 fields 955 may include an extra bit to indicate whether the packet extension 907 of the packet 900 of FIG. 9A includes sounding LTFs. In some aspects, the extra bit may store a “1” to indicate that the packet extension 907 contains sounding LTFs, and may store a “0” to indicate that the packet extension 907 does not contain sounding LTFs.

In some implementations, the sounding LTFs contained in the packet extensions of the HE packets of the ranging operation 500A of FIG. 5A may be based on the HE-LTFs used in HE NDPs (which are designed for wideband channel sounding operations). For these HE packets, the HE-SIG-A1 and HE-SIG-A2 fields 955 may be modified to include a number of extra sets of fields to store parameters for the NDP-based HE-LTFs contained in the packet extension 907.

In some aspects, each of these extra sets of fields may be of a similar format as the set of fields described with respect to the HE-LTF 958. For each extra set of fields (in the HE-SIG-A1 and HE-SIG-A2 fields 955) that describes a corresponding NDP-based HE-LTF contained in packet extension 907, the Nsts field stores information indicating the number of spatial streams used to transmit the NDP-based HE-LTF, the STBC stores a value that disables space-time block coding, and the TxBF field stores a value that disables beamforming (because using a beamforming matrix to transmit the NDP-based HE-LTF may change the channel information as seen by the receiving device).

In some other aspects, one or more fields in each of the extra sets of field may be eliminated to minimize packet length. For example, the CP+LTF Size field may be removed by mandating that the CP+LTF Size in the packet extension 907 is the same as in the preamble 901. For another example, the STBC field may be removed by mandating that space-time block coding is to be disabled. For another example, the TxBF field may be removed by mandating that beamforming is to be disabled.

The HE-SIG-B field 956 may include resource unit (RU) allocation information associated with orthogonal frequency division multiple access (01-DMA) transmissions.

Information contained in the HE-STF 957 may be used to improve automatic gain control estimates for SU-MIMO and MU-MIMO communications, and information contained in the HE-LTF 958 may be used to estimate various MIMO channel conditions. More specifically, in some implementations, the HE-LTF 958 may include information from which an RTT measurement may be determined, for example, as described with respect to FIGS. 5A-5C. In some aspects, one or more copies of the HE-LTF 958 may be provided within the packet extension 907 of the packet 900.

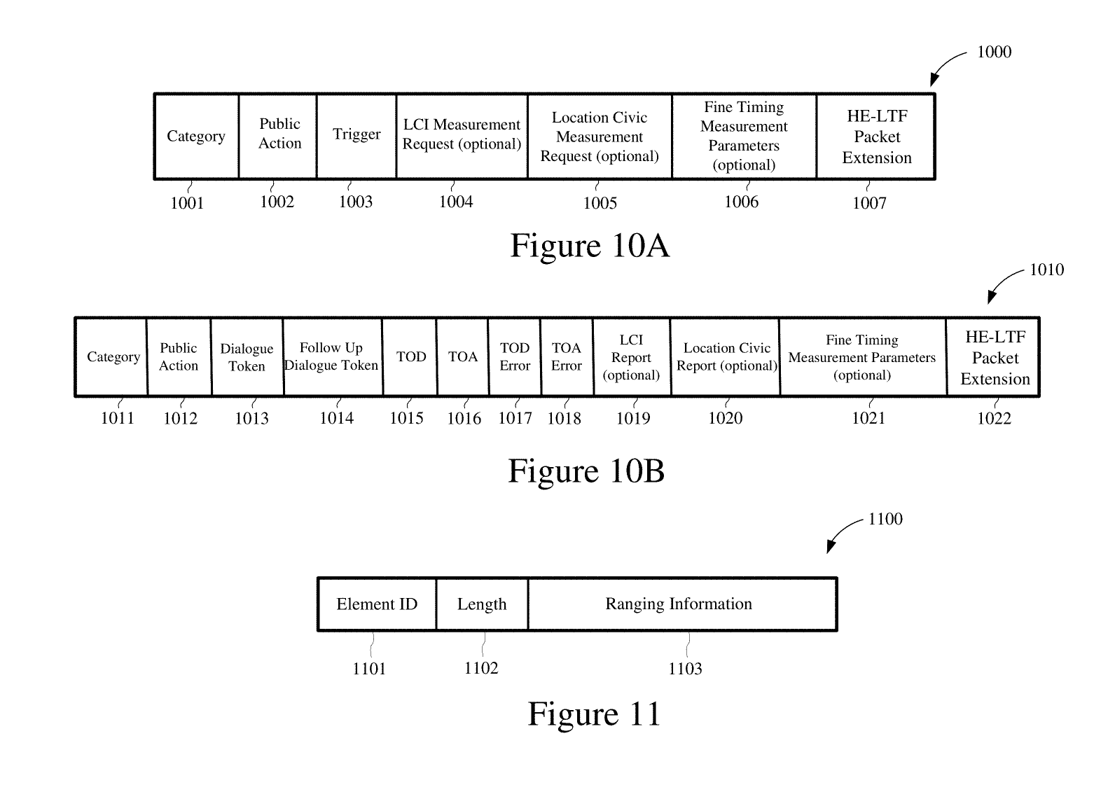

FIG. 10A shows an example FTM_REQ frame 1000. The FTM_REQ frame 1000 may be used in the example ranging operation 500A of FIGS. 5A-5C. The FTM_REQ frame 1000 may include a category field 1001, a public action field 1002, a trigger field 1003, an optional location civic information (LCI) measurement request field 1004, an optional location civic measurement request field 1005, an optional FTM parameters field 1006, and an HE-LTF packet extension 1007. The fields 1001-1006 of the FTM_REQ frame 1000 are well-known, and therefore are not discussed in detail herein. In some aspects, the HE-LTF packet extension 1007 may be one implementation of the packet extension 907 of the packet 900 of FIG. 9A.

FIG. 10B depicts an example FTM frame 1010. The FTM frame 1010 may be used in the ranging operation 500A of FIGS. 5A-5C. The FTM frame 1010 may include a category field 1011, a public action field 1012, a dialogue token field 1013, a follow up dialog token field 1014, a TOD field 1015, a TOA field 1016, a TOD error field 1017, a TOA error field 1018, an optional LCI report field 1019, an optional location civic report field 1020, an optional FTM parameters field 1021, and an HE-LTF packet extension 1022. The fields 1011-1021 of the FTM frame 1010 are well-known, and therefore are not discussed in detail herein. The HE-LTF packet extension 1022 may be one implementation of the packet extension 907 of the packet 900 of FIG. 9A. A number of reserved bits in the TOD error field 1017, a number of reserved bits in the TOA error field 1018, or a number of reserved bits in the TOD error field 1017 and the TOA error field 1018 of the FTM frame 1010 may be used to store an antenna mask.

FIG. 11 shows an example vendor-specific information element (VSIE) 1100. The VSIE 1100 may include an Element ID field 1101, a Length field 1102, and a Ranging Information field 1103. In some implementations, the Element ID field 1101 may include one byte, the Length field 1102 may include one byte, and the Ranging Information field 1103 may include one byte (although in some other implementations, other field lengths may be used). The Element ID field 1101 may store an element ID value indicating that VSIE 1100 contains requests and parameters for one or more of the ranging operations disclosed herein. The Length field 1102 may store a value indicating a length (in bytes) of the Ranging Information field 1103.

The Ranging Information field 1103 may include requests for the ranging operations disclosed herein, a requested packet extension length, and one or more ranging parameters. In implementations for which the VSIE 1100 is included within the FTM_REQ frame of FIG. 5A, the Ranging Information field 1103 may include a request for the second device D2 to initiate one or more of the ranging operations and may request a packet extension length to be used by the second device D2 when transmitting FTM frames to the first device D1. In implementations for which the VSIE 1100 is included within the FTM_1 frame of FIG. 5A, the Ranging Information field 1103 may include one or more ranging parameters including, for example, the number of sounding LTFs contained in the packet extension of an HE packet, the length or transmit duration of the packet extension, the number of transmit antennas (Ntx) used to transmit the HE packet, the number of spatial streams (Nsts) upon which the packet extension is transmitted, and a size or duration of the sounding LTFs.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A method of performing a ranging operation, comprising:
transmitting, to a wireless device, a frame requesting a length of packet extensions to be used for the ranging operation;
receiving, from the wireless device, a high efficiency (HE) packet including a packet extension that contains a selected number of long training fields (LTFs), wherein the selected number of LTFs is based at least in part on the requested packet extension length;
determining that the packet extension contains LTFs; and
performing the ranging operation with the wireless device based on a determination that the packet extension contains LTFs.

2. The method of claim 1, wherein performing the ranging operation comprises:
estimating angle of departure (AoD) information or angle of arrival (AoA) information of the HE packet based on the selected number of LTFs contained in the packet extension.

3. The method of claim 2, wherein performing the ranging operation further comprises:
transmitting, to the wireless device, a feedback frame including the estimated AoD information or AoA information.

4. The method of claim 1, wherein the LTFs contained in the packet extension comprise one of high-efficiency long training fields (HE-LTFs), very-high-throughput long training fields (VHT-LTFs), high-throughput long training fields (HT-LTFs), legacy LTFs, and a high-efficiency null data packet (HE-NDP).

5. The method of claim 1, wherein the HE packet includes a field indicating at least one of a number of antennas used to transmit the packet extension, a number of spatial streams used to transmit the packet extension, the length of the packet extension, and a size or duration of the LTFs.

6. The method of claim 1, wherein the frame comprises a fine timing measurement (FTM) request frame, and the HE packet comprises an FTM action frame.

7. The method of claim 1, wherein the determining comprises:
detecting, in a preamble of the HE packet, a bit indicating that the packet extension contains LTFs.

8. The method of claim 1, wherein the determining comprises:
extracting patterns from the packet extension; and
correlating the extracted patterns with a number of reference sequences.

9. The method of claim 1, further comprising:
determining a length of the packet extension; and
determining how many antennas of the wireless device transmitted the packet extension based, at least in part, on the determined length.

10. An apparatus for performing a ranging operation, comprising:
one or more transceivers configured to receive wireless signals from a wireless device;
one or more processors; and
a memory comprising instructions that, when executed by the one or more processors, cause the apparatus to:
transmit, to the wireless device, a frame requesting a length of packet extensions to be used for the ranging operation;
receive, from the wireless device, a high efficiency (HE) packet including a packet extension that contains a selected number of long training fields (LTFs), wherein the selected number of LTFs is based at least in part on the requested packet extension length;
determine that the packet extension contains LTFs; and
perform the ranging operation with the wireless device based on a determination that the packet extension contains LTFs.

11. The apparatus of claim 10, wherein execution of the instructions for performing the ranging operation further causes the apparatus to:
estimate angle of departure (AoD) information or angle of arrival (AoA) information of the HE packet based on the selected number of LTFs contained in the packet extension.

12. The apparatus of claim 11, wherein execution of the instructions for performing the ranging operation further causes the apparatus to:
transmit, to the wireless device, a feedback frame including the estimated AoD information or AoA information.

13. The apparatus of claim 10, wherein the HE packet includes a field indicating at least one of a number of antennas used to transmit the packet extension, a number of spatial streams used to transmit the packet extension, the length of the packet extension, and a size or duration of the LTFs.

14. The apparatus of claim 10, wherein the frame comprises a fine timing measurement (FTM) request frame, and the HE packet comprises an FTM action frame.

15. The apparatus of claim 10, wherein execution of the instructions for determining that the packet extension contains LTFs further causes the apparatus to:
detect, in a preamble of the HE packet, a bit indicating that the packet extension contains LTFs.

16. The apparatus of claim 10, wherein execution of the instructions for determining that the packet extension contains LTFs further causes the apparatus to:
extract patterns from the packet extension; and
correlate the extracted patterns with a number of reference sequences.

17. The apparatus of claim 10, wherein execution of the instructions further causes the apparatus to:
determine a length of the packet extension; and
determine how many antennas of the wireless device transmitted the packet extension based, at least in part, on the determined length.

18. A method of performing a ranging operation, comprising:
receiving, from a wireless device, a frame requesting a length of packet extensions to be used for the ranging operation;
selecting a number of long training fields (LTFs) based, at least in part, on the requested packet extension length; and
transmitting, to the wireless device, a high efficiency (HE) packet including a packet extension containing the selected number of LTFs.

19. The method of claim 18, further comprising:
receiving, from the wireless device, a feedback frame including estimated angle of departure (AoD) information or angle of arrival (AoA) information of the HE packet.

20. The method of claim 19, wherein the estimated AoD information or the AoA information is based on the selected number of LTFs contained in the packet extension.

21. The method of claim 18, wherein the LTFs contained in the packet extension comprise one of high-efficiency long training fields (HE-LTFs), very-high-throughput long training fields (VHT-LTFs), high-throughput long training fields (HT-LTFs), legacy LTFs, and a high-efficiency null data packet (HE-NDP).

22. The method of claim 18, wherein the selecting further comprises:
determining a number of antennas from which to transmit the HE packet extension; and
determining a number of spatial streams upon which to transmit the packet extension, wherein the selected number of LTFs is further based on at least one of the determined number of antennas, the determined number of spatial streams, and a size or duration of the LTFs.

23. The method of claim 18, wherein the frame comprises a fine timing measurement (FTM) request frame, and the HE packet comprises an FTM action frame.

24. The method of claim 18, wherein the HE packet includes a field indicating at least one of a number of antennas from which the packet extension is transmitted, a number of spatial streams upon which the packet extension is transmitted, the length of the packet extension, and a size or duration of the LTFs.

25. The method of claim 18, wherein transmitting the HE packet extension comprises:
transmitting a first group of LTFs using a first set of antennas; and
transmitting the first group of LTFs using a second set of antennas, offset in time relative to the transmission of the first group of LTFs using the first set of antennas.

26. An apparatus for performing a ranging operation, comprising:
one or more transceivers configured to receive wireless signals from a wireless device;
one or more processors; and
a memory comprising instructions that, when executed by the one or more processors, cause the apparatus to:
receive, from the wireless device, a frame requesting a length of packet extensions to be used for the ranging operation;
select a number of long training fields (LTFs) based, at least in part, on the requested packet extension length; and
transmit, to the wireless device, a high efficiency (HE) packet including a packet extension containing the selected number of LTFs.

27. The apparatus of claim 26, wherein execution of the instructions further causes the apparatus to:
receive, from the wireless device, a feedback frame including estimated angle of departure (AoD) information or angle of arrival (AoA) information of the HE packet.

28. The apparatus of claim 26, wherein execution of the instructions to select the number of LTFs causes the apparatus to:
determine a number of antennas from which to transmit the HE packet extension; and
determine a number of spatial streams upon which to transmit the packet extension, wherein the selected number of LTFs is further based on at least one of the determined number of antennas, the determined number of spatial streams, and a size or duration of the LTFs.

29. The apparatus of claim 26, wherein the HE packet includes a field indicating at least one of a number of antennas from which the packet extension is transmitted, a number of spatial streams upon which the packet extension is transmitted, the length of the packet extension, and a size or duration of the LTFs.

30. The apparatus of claim 26, wherein execution of the instructions to transmit the HE packet extension causes the apparatus to:
transmit a first group of LTFs using a first set of antennas; and
transmit the first group of LTFs using a second set of antennas, offset in time relative to the transmission of the first group of LTFs using the first set of antennas.
